(19) United States
(12) Patent Application Publication
(10) Pub. No.: US 2017/0182988 A1
(43) Pub. Date: Jun. 29, 2017

(54) Brake Apparatus and Master Cylinder

(71) Applicant: Hitachi Automotive Systems, Ltd., Hitachinaka-shi, Ibaraki (JP)

(72) Inventors: Takahiro KAWAKAMI, Atsugi-shi, Kanagawa (JP); Chiharu NAKAZAWA, Kawasaki-shi, Kanagawa (JP); Ryohei MARUO, Kawasaki-shi, Kanagawa (JP)

(73) Assignee: Hitachi Automotive Systems, Ltd., Hitachinaka-shi, Ibaraki (JP)

(21) Appl. No.: 15/325,159

(22) PCT Filed: Jul. 10, 2015
(86) PCT No.: PCT/JP2015/069936

§ 371 Date: Jan. 10, 2017

(30) Foreign Application Priority Data
Jul. 15, 2014 (JP) 2014-145057

(51) Int. Cl. B60T 8/36; B60T 11/16; B60T 13/68; B60T 11/22

(52) U.S. Cl. CPC B60T 8/368; B60T 11/22; B60T 11/165; B60T 13/686; B60T 2220/04

(57) ABSTRACT

An object of the present invention is to provide a brake apparatus capable of reducing a size and a weight. A brake apparatus according to the present invention includes a master cylinder housing including a first port that connects an inside and an outside of a cylinder, and a valve housing including an oil passage through which brake fluid introduced from a second port connected to the first port flows. One side of the master cylinder housing where one side surface thereof is located is attached to one side of the valve housing where one side surface thereof is located. The brake apparatus includes a connection portion that connects the first port and the second port between the one side surface of the master cylinder housing and the one side of the valve housing where the one side surface thereof is located. A space opened to respective outsides of the housings is formed around the connection portion

### TECHNICAL FIELD

The present invention relates to a brake control apparatus and a master cylinder that provide a braking force to a vehicle.

### BACKGROUND ART

Conventionally, there is known a technique discussed in PTL 1 as a brake apparatus. The technique discussed in this patent literature fixes a master cylinder unit and a hydraulic control unit to each other with use of bolts, thereby eliminating a pipe and the like to achieve a reduction in a size.

### CITATION LIST

### Patent Literature

PTL 1: Japanese Patent Application Public Disclosure No. 2004-168281

### SUMMARY OF INVENTION

### Technical Problem

However, integrating the units in planar contact with each other with use of the bolts, like PTL 1, leads to a necessity of a high tightening torque to ensure liquid-tightness of brake fluid flowing back and forth between both the units. Therefore, the units should be thick to ensure strength around the bolts, resulting in increases in the size and the weight.

The present invention is directed to providing a brake apparatus capable of reducing the size and the weight.

### Solution to Problem

According to an aspect of the present invention, a brake apparatus includes a master cylinder housing including a first port that connects an inside and an outside of a cylinder, and a valve housing including an oil passage through which brake fluid introduced from a second port connected to the first port flows. One side of the master cylinder housing where one side surface thereof is located is attached to one side of the valve housing where one side surface thereof is located. The brake apparatus includes a connection portion that connects the first port and the second port between the one side surface of the master cylinder housing and the one side of the valve housing where the one side surface thereof is located. A space opened to respective outsides of the housings is formed around the connection portion.

Embodiments according to the brake apparatus of the present invention, which will be described below, can enhance liquid-tightness due to an increase in a surface pressure at the connection portion between the first port and the second port. Further, the embodiments can reduce a weight of the brake apparatus due to the provision of the space.

### BRIEF DESCRIPTION OF DRAWINGS

FIG. 1 is a system diagram illustrating a configuration of a brake according to a first embodiment.

FIG. 2 is a perspective view illustrating a brake apparatus according to the first embodiment.

FIG. 3 is a perspective view illustrating the brake apparatus according to the first embodiment.

FIG. 4 is a front view illustrating the brake apparatus according to the first embodiment.

FIG. 5 is a back view illustrating the brake apparatus according to the first embodiment.

FIG. 6 is a left side view illustrating the brake apparatus according to the first embodiment.

FIG. 7 is a right side view illustrating the brake apparatus according to the first embodiment.

FIG. 8 is a cross-sectional view illustrating the brake apparatus according to the first embodiment taken along a line A-A.

FIG. 9 is a plan view illustrating the brake apparatus according to the first embodiment.

FIG. 10 is a bottom view illustrating the brake apparatus according to the first embodiment.

FIG. 11 is a cross-sectional view illustrating the brake apparatus according to the first embodiment taken along a line B-B.

FIG. 12 is a cross-sectional view illustrating the brake apparatus according to the first embodiment taken along a line C-C.

FIG. 13 illustrates an internal layout of an ECU provided to the brake apparatus according to the first embodiment.

FIG. 14 is an enlarged perspective view of a stroke sensor portion provided to the brake apparatus according to the first embodiment.

FIG. 15 is an exploded perspective view illustrating the brake apparatus according to the first embodiment.

FIG. 16 is a perspective view illustrating a configuration of a first unit housing according to the first embodiment.

FIG. 17 is a perspective view illustrating a second unit housing according to the first embodiment as viewed from one side where a first attachment surface 5b1 is located.

FIG. 18 is a plan view when the first unit housing and the second unit housing according to the first embodiment are attached to each other.

FIG. 19 is a perspective view illustrating a configuration of a first unit housing according to a second embodiment.

FIG. 20 is a perspective view illustrating a configuration of a second unit housing according to the second embodiment.

### DESCRIPTION OF EMBODIMENTS

### First Embodiment

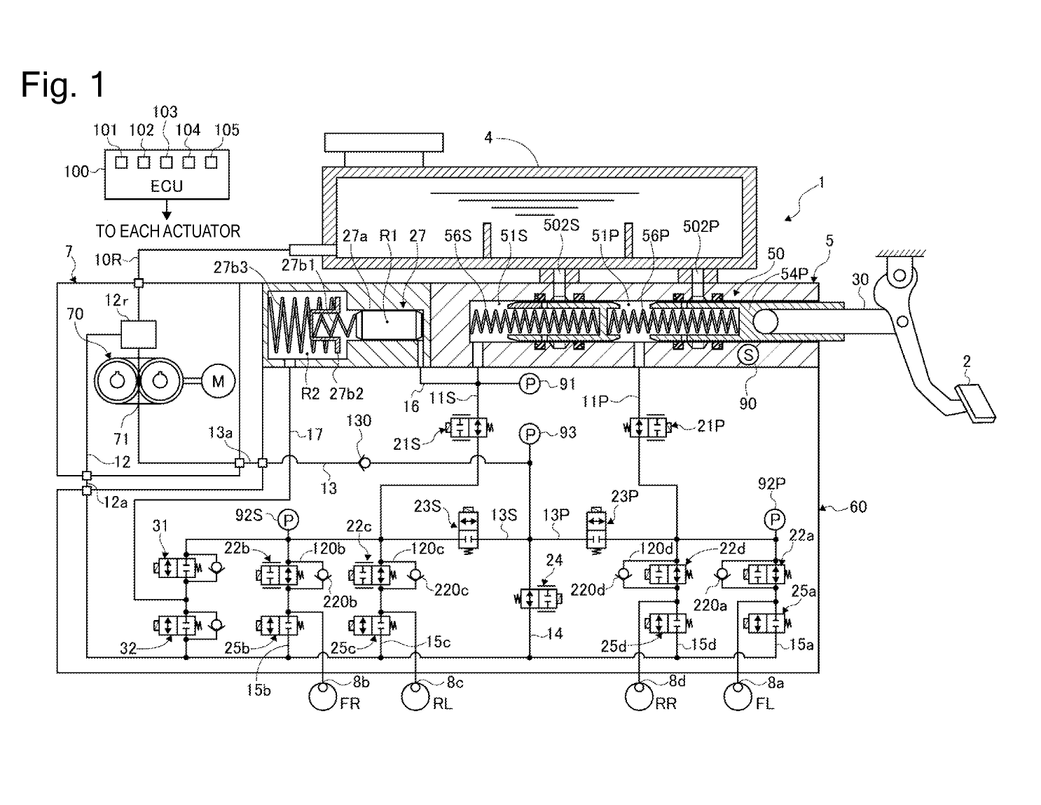

FIG. 1 schematically illustrates a configuration of a brake apparatus according to a first embodiment together with a hydraulic circuit. A brake apparatus 1 is a hydraulic brake apparatus applied to a brake system of an electric vehicle, such as a hybrid vehicle including an electric motor (a generator) besides an engine and an electric vehicle including only the electric motor (the generator) as a prime mover that drives wheels. Such an electric vehicle can carry out regenerative braking, which brakes the vehicle by converting a kinetic energy of the vehicle into electric energy with use of a regenerative braking apparatus including the motor (the generator). The brake apparatus 1 supplies brake fluid working as hydraulic fluid to a brake actuation unit mounted on each of wheels FL to RR of the vehicle to generate a brake hydraulic pressure (a wheel cylinder hydraulic pressure), thereby applying a hydraulic braking force to each of the wheels FL to RR.

The brake actuation unit including a wheel cylinder 8 is a so-called disk type brake device. The brake actuation unit includes a brake disk and a caliper (a hydraulic brake caliper). The brake disk is a brake rotor that rotates integrally with a tire. The caliper is disposed with a predetermined clearance (a space, or a gap due to loose mounting) generated between the caliper and the brake disk, and includes a brake pad that generates the braking force by being displaced by the wheel cylinder hydraulic pressure into contact with the brake disk. The brake apparatus 1 includes two brake pipe systems (a primary P system and a secondary S system). For example, a so-called X-split pipe configuration is employed as the brake pipe systems. The brake apparatus 1 may employ another piping method, such as a front/rear split pipe configuration. Hereinafter, when a component provided in correspondence with the P system and a component provided in correspondence with the S system should be distinguished from each other, indices P and S will be added at the ends of the respective reference numerals.

The brake apparatus 1 includes a brake pedal 2, a reservoir tank (hereinafter referred to as a reservoir) 4, a master cylinder unit 5, and a pump unit 7. The brake pedal 2 serves as a brake operation member that receives an input of a brake operation performed by an operator (a driver). The reservoir 4 is a brake fluid source that stores the brake fluid therein, and is a low-pressure portion opened to an atmospheric pressure. The master cylinder unit 5 is connected to the brake pedal 2 and is replenished with the brake fluid from the reservoir 4, and generates a brake hydraulic pressure (a master cylinder pressure) by being actuated by the operation that the driver performs on the brake pedal 2. The pump unit 7 generates a hydraulic pressure by a motor M. The master cylinder unit 5 includes a master cylinder portion 50, a hydraulic control portion 60, and an electronic control unit (hereinafter referred to as an ECU) 100. The master cylinder portion 50 generates the master cylinder pressure by the operation performed on the brake pedal 2. The hydraulic control portion 60 receives a supply of the brake fluid from the reservoir 4 or the master cylinder portion 50, and includes a plurality of electromagnetic valves and the like for generating the brake hydraulic pressure independently of the brake operation performed by the driver. The ECU 100 controls actuation of this plurality of electromagnetic valves and the like, and the pump unit 7. Hereinafter, the various kinds of electromagnetic valves will be referred to as electromagnetic valves 20, when they are collectively referred to.

The brake apparatus 1 does not include an engine negative-pressure booster that boosts the brake operation force by utilizing an intake negative pressure generated by the engine of the vehicle. A push rod 30 is rotatably connected to the brake pedal 2. The master cylinder portion 50 is a tandem-type master cylinder. The master cylinder portion 50 includes a primary piston 54P connected to the push rod 30 and a secondary piston 54S configured as a free piston as master cylinder pistons axially displaceable according to the brake operation performed by the driver. The primary piston 54P is provided with a stroke sensor 90 that detects the pedal stroke. Details of the stroke sensor 90 will be described below.

The hydraulic control portion 60 is provided between the wheel cylinders 8 and the master cylinder portion 50. The hydraulic control portion 60 performs control so as to be able to individually supply the master cylinder pressure or a control hydraulic pressure to each of the wheel cylinders 8. The hydraulic control portion 60 includes a plurality of control valves as actuators for generating the control hydraulic pressure. The electromagnetic valves and the like perform an opening/closing operation according to a control signal, thereby controlling a flow of the brake fluid. The hydraulic control portion 60 can perform control of increasing the pressures in the wheel cylinders 8 with use of the hydraulic pressure generated by the pump unit 7 with the master cylinder portion 50 and the wheel cylinders 8 out of communication with each other. The hydraulic control portion 60 includes a stroke simulator 27 that creates a pedal reaction force (a pedal reaction force and a pedal stroke amount) by supply of the brake fluid from the master cylinder portion 50 according to the brake operation performed by the driver. The stroke simulator 27 may be provided integrally as a part of the hydraulic control portion 60, or may be provided separately from the hydraulic control portion 60. Further, hydraulic sensors 91 to 93, which detect a discharge pressure of the pump unit 7 and the master cylinder pressure, are mounted in the master cylinder unit 5. The pump unit 7 is configured as a different unit from the master cylinder unit 5. The pump unit 7 is connected to the master cylinder unit 5 and the reservoir 4 via pipes (a connection pipe 10R, an intake pipe 12a, and a discharge pipe 13a). The pump unit 7 introduces therein the brake fluid in the reservoir 4 and discharges the brake fluid toward the wheel cylinders 8 by the motor M being rotationally driven. In the present embodiment, the pump unit 7 is embodied by an external gear pump (hereinafter referred to as a gear pump 70), which is excellent in terms of a noise and vibration performance and the like. The pump unit 7 is used in common by both of the systems. The pump unit 7 is driven by the same motor M. The motor M may be a brushless motor or may be a brushed motor.

Detection values transmitted from the stroke sensor 90 and the hydraulic sensors 91 to 93, and information regarding a running state transmitted from the vehicle are input to the ECU 100. The ECU 100 controls each of the actuators in the hydraulic control portion 60 based on a program installed therein. More specifically, the ECU 100 controls the opening/closing operations of the electromagnetic valves that switch communication states of oil passages, and the number of rotation of the motor M that drives the pump unit 7 (i.e., the discharge amount of the pump unit 7). By this operation, the brake apparatus according to the first embodiment realizes boosting control for reducing a brake operation force, anti-lock brake control (hereinafter referred to as ABS) for preventing or reducing a slip of a wheel that might be caused when the vehicle is braked, control of a motion of the vehicle (brake control for vehicle dynamics control such as electronic stability control, which will be hereinafter referred to as VDC), automatic brake control such as adaptive cruise control, regenerative brake control that controls the wheel cylinder hydraulic pressure so as to achieve a target deceleration (a target braking force) by collaborating with the regenerative brake, and the like. In the boosting control, the ECU 100 drives the hydraulic control portion 60 with use of the discharge pressure of the pump unit 7 as a hydraulic source, when the driver performs the brake operation. In the boosting control, the ECU 100 creates a higher wheel cylinder hydraulic pressure than the master cylinder pressure, thereby generating a hydraulic braking force for compensating for insufficiency of the brake operation force input by the driver. The boosting control allows the brake apparatus to exert a boosting function that assists the brake operation. In other words, the brake apparatus assists the brake operation force by actuating the hydraulic control portion 60 and the pump unit 7 instead of the engine negative-pressure booster. In the regenerative brake control, the ECU 100 generates a hydraulic braking force for compensating for insufficiency of a regenerative braking force generated by the regenerative braking apparatus insufficient to, for example, generate a braking force requested by the driver.

The master cylinder portion 50 is a first hydraulic source connected to the wheel cylinders 8 via first oil passages 11, which will be described below, and capable of increasing the wheel cylinder hydraulic pressures. The master cylinder portion 50 can increase the pressures in wheel cylinders 8a and 8d via an oil passage (a first oil passage 11P) in the P system with use of a master cylinder pressure generated in a first fluid chamber 51P. At the same time, the master cylinder portion 50 can increase the pressures in wheel cylinders 8b and 8c via a first oil passage 11S in the S system with use of a master cylinder pressure generated in a second fluid chamber 51S. The pistons 54P and 54S in the master cylinder portion 50 are inserted axially displaceably along an inner peripheral surface of a bottomed cylindrical cylinder. The cylinder includes a discharge port (a supply port) 501 and a replenishment port 502 for each of the P and S systems. The discharge port 501 is provided so as to be connectable to the hydraulic control portion 60 to establish communication with the wheel cylinders 8. The replenishment port 502 is connected to the reservoir 4 and is in communication with the reservoir 4. A coil spring 56P as a return spring is set in the first fluid chamber 51P between the pistons 54P and 54S in a pressed and compressed state. A coil spring 56S is set in the second fluid chamber 51S between the piston 54S and an axial end of the cylinder in a pressed and compressed state. The discharge ports 501 are normally opened to the first and second fluid chambers 51P and 51S.

In the following description, a brake hydraulic circuit of the master cylinder unit 5 will be described with reference to FIG. 1. Members corresponding to the individual wheels FL to RR will be distinguished from one another if necessary, by indices a to d added at the ends of reference numerals thereof, respectively. The hydraulic control portion 60 includes the first oil passages 11, normally opened shut-off valves 21, normally opened pressure-increase valves (hereinafter referred to as SOL/V INs) 22, an intake oil passage 12, a discharge oil passage 13, a check valve 130, a normally-opened communication valve 23P, a normally-closed communication valve 23S, a first pressure-reduction oil passage 14, a normally-closed pressure adjustment valve 24, second pressure-reduction oil passages 15, normally closed pressure-reduction valves 25, a first simulator oil passage 16, and a second simulator oil passage 17. The first oil passages 11 connect the discharge ports 501 (the first and second fluid chambers 51P and 51S) of the master cylinder portion 50 and the wheel cylinders 8 to each other. The shut-off valves 21 are provided in the first oil passages 11. The pressure-increase valves 22 are provided (in oil passages 11a to 11d) on one side of the hydraulic control portion 60 that is closer to the wheel cylinders 8 with respect to the shut-off valves 21 in the first oil passages 11 in correspondence with the wheels FL to RR, respectively. The intake oil passage 12 connects a fluid pool 12r provided at an intake portion of the pump unit 7 and the pressure-reduction oil passages 15, which will be described below, to each other. The discharge oil passage 13 connects portions in the first oil passages 11 between the shut-off valves 21 and the SOL/V INs 22, and a discharge portion of the pump unit 7 to each other. The check valve 130 is provided in the discharge oil passage 13, and permits only a flow of the brake fluid from one side of the pump unit 7 where the discharge portion 71 is located to one side of the hydraulic control portion 60 where the first oil passages 11 are located. The communication valve 23P is provided in the discharge oil passage 13P connecting a downstream side of the check valve 130 and the first oil passage 11P in the P system to each other. The communication valve 23S is provided in a discharge oil passage 13S connecting the downstream side of the check valve 130 and the first oil passage 11S in the S system to each other. The first pressure-reduction oil passage 14 connects a portion in a discharge oil passage 13P between the check valve 130 and the communication valve 23P, and the intake oil passage 12 to each other. The pressure adjustment valve 24 serves as a first pressure-reduction valve provided in the first pressure-reduction oil passage 14. The second pressure-reduction oil passages 15 connect the one side of the hydraulic control portion 60 that is closer to the wheel cylinders 8 than to the SOL/V INs 22 in the first oil passages 11, and the intake oil passage 12 to each other. The pressure-reduction valves 25 serve as second pressure-reduction valves provided in the second pressure-reduction oil passages 15. The first simulator oil passage 16 serves as a branch oil passage branching off from the master cylinder side with respect to the shut-off valve 21S in the first oil passage 11S to be connected to a main chamber R1 of the stroke simulator 27. The second simulator oil passage 17 connects an auxiliary chamber (a backpressure chamber) R2 of the stroke simulator 27, and the intake oil passage 12 and the discharge oil passage 13 to each other via a stroke simulator IN valve 31 and a stroke simulator OUT valve 32.

In the pump unit 7, the fluid pool 12r is provided at a portion where the connection pipe 10R extending from the reservoir 4 is connected to the intake oil passage 12 of the pump unit 7. The discharge oil passages 13P and 13S form communication passages connecting the first oil passage 11P in the P system and the first oil passage 11S in the S system to each other. The pump unit 7 is connected to the wheel cylinders 8a to 8d via the above-described communication passages (the discharge oil passages 13P and 13S) and the first oil passages 11P and 11S. The pump unit 7 serves as a second hydraulic source capable of increasing the wheel cylinder hydraulic pressures by discharging the brake fluid to the above-described communication passages (the discharge oil passages 13P and 13S). At least one of the shut-off valves 21, the SOL/V INs 22, the communication valve 23P, the pressure adjustment valve 24, and the pressure-reduction valves 25 of each of the systems (the SOL/V INs 22 and the pressure adjustment valve 24 in the present embodiment) is a proportional control valve, an opening degree of which is adjusted according to a current supplied to a solenoid. The other valves are ON/OFF valves, opening/closing of which is controlled to be switched between two values, i.e., switched to be either opened or closed. The proportional control valve can also be employed as the above-described other valves.

The shut-off valves 21 are provided in the first oil passages 11P and 11S. Bypass oil passages 120 are provided in parallel with the first oil passages 11 by bypassing the SOL/V INs 22. Further, the bypass oil passages 120 include check valves 220, which permit only a flow of the brake fluid from the one side closer to the wheel cylinders 8 to the other side closer to the master cylinder 5. The hydraulic sensor 91 is provided in the first simulator oil passage 16. The hydraulic sensor 91 detects a hydraulic pressure at this portion (a hydraulic pressure in the stroke simulator 27, and corresponds to the master cylinder pressure). The hydraulic sensors 92 are provided between the shut-off valves 21 and the SOL/V INs 22 in the first oil passages 11. The hydraulic sensors 92 detect hydraulic pressures at these portions (the wheel cylinder hydraulic pressures). The hydraulic sensor 93 is provided between the check valve 130 and the communication valve 23 in the discharge oil passage 13P. The hydraulic sensor 93 detects a hydraulic pressure at this portion (the discharge pressure of the pump).

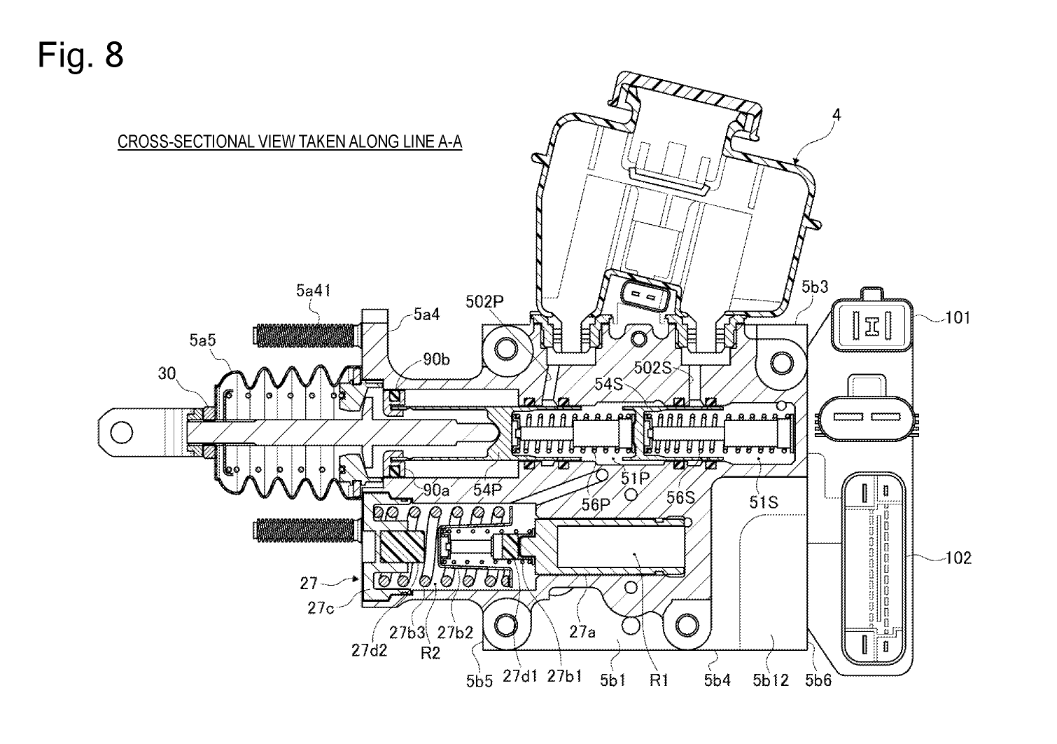

The stroke simulator 27 includes a piston 27a, a first spring 27b1, a retainer member 27b2, and a second spring 27b3. The piston 27a is disposed axially displaceably in a chamber R while dividing an inside of the chamber R into two chambers (the main chamber R1 and the auxiliary chamber R2). The spring 27b1 is an elastic member mounted in the auxiliary chamber R2 in a pressed and compressed state, and constantly biasing the piston 27a toward one side where the main chamber R1 is located (in a direction for reducing a volume of the main chamber R1 and increasing a volume of the auxiliary chamber R2). The retainer member 27b2 holds the first spring 27b1. The second spring 27b3 is an elastic member constantly biasing the retainer member 27b2 toward the one side where the main chamber R1 is located. A first damper 27d1 and a second damper 27d2 are provided inside the retainer member 27b2 and at a plug member 27c, respectively, for the purpose of improving a pedal feeling (refer to FIG. 8). Hereinafter, the first spring 27b1 and the second spring 27b3 will be collectively referred to as the springs 27b.

When the stroke simulator IN valve 31 and the stroke simulator OUT valve 32 are controlled in an opening direction and a closing direction, respectively, with the shut-off valves 21 controlled in opening directions, the brake system (the first oil passages 11) connecting the first and second fluid chambers 51P and 51S of the master cylinder 5 and the wheel cylinders 8 to each other creates the wheel cylinder hydraulic pressures by the master cylinder pressure generated with use of the force of pressing the pedal, thereby realizing pressing force brake (non-boosting control). On the other hand, when the stroke simulator valve IN valve 31 and the stroke simulator OUT valve 32 are controlled in a closing direction and an opening direction, respectively, with the shut-off valves controlled in closing directions, the brake system connecting the reservoir 4 and the wheel cylinders 8 to each other (the intake oil passage 12, the discharge oil passage 13, and the like) forms a so-called brake-by-wire system that creates the wheel cylinder hydraulic pressures by the hydraulic pressure generated with use of the pump unit 7, thereby realizing the boosting control, the regenerative control, and the like.

With the shut-off valves 21 controlled in the closing directions to block the communication between the master cylinder 5 and the wheel cylinders 8, the stroke simulator 27 causes at least the brake fluid flowing out from the master cylinder portion 50 (the first fluid chamber 51S) into the first oil passage 11S to be introduced into the main chamber R1 via the first simulator oil passage 16, thereby creating the pedal reaction force. With the shut-off valve 21S closed to block the communication between the master cylinder portion 50 and the wheel cylinders 8, and the stroke simulator OUT valve 32 opened to establish the communication between the master cylinder portion 50 and the stroke simulator 27, the stroke simulator 27 introduces and discharges the brake fluid from the master cylinder 5, thereby creating the pedal reaction force, when the driver performs the brake operation (presses the brake pedal 2 or releases the pressed brake pedal 2). More specifically, when a hydraulic pressure (the master cylinder pressure) equal to or higher than a predetermined pressure is applied to a pressure-receiving surface of the piston 27a in the main chamber R1, the piston 27a is axially displaced toward the other side where the auxiliary chamber R2 is located while pressing and compressing the spring 27b, thereby increasing the volume of the main chamber R1. As a result, the brake fluid is delivered from the master cylinder 5 (the discharge port 501P) into the main chamber R1 via the oil passages (the first oil passage 11S and the first simulator oil passage 16). At the same time, the brake fluid is discharged from the auxiliary chamber R2 into the intake oil passage 12 via the second simulator oil passage 17. When the pressure in the main chamber R reduces to lower than the predetermined pressure, the piston 27a is returned to an initial position due to the biasing force (an elastic force) of the spring 27b. The stroke simulator 27 introduces therein the brake fluid from the master cylinder 5 in this manner, thereby simulating hydraulic stiffness of the wheel cylinders 8 to imitate a feeling that the driver would have when pressing the pedal.

The ECU 100 forms a hydraulic controller that actuates the pump unit 7, the electromagnetic valves, and the like based on various kinds of information to control the hydraulic pressures in the wheel cylinders 8. The ECU 100 includes a brake operation amount detection portion 101, a target wheel cylinder hydraulic pressure calculation portion 102, a pressing force brake creation portion 103, a boosting control portion 104, and a boosting control switching portion 105. The brake operation amount detection portion 101 detects a displacement amount (the pedal stroke) of the brake pedal 2 as the brake operation amount upon receiving the input of the value detected by the stroke sensor 90. The target wheel cylinder hydraulic pressure calculation portion 102 calculates a target wheel cylinder hydraulic pressure. More specifically, the target wheel cylinder hydraulic pressure calculation portion 102 calculates the target wheel cylinder hydraulic pressure that realizes a predetermined boosting rate, i.e., an ideal characteristic about a relationship between the pedal stroke and a brake hydraulic pressure requested by the driver (a vehicle deceleration G requested by the driver) based on the detected pedal stroke. Further, in the regenerative brake control, the target wheel cylinder hydraulic pressure calculation portion 102 calculates the target wheel cylinder hydraulic pressure in relation to the regenerative braking force. More specifically, the target wheel cylinder hydraulic pressure calculation portion 102 calculates such a target wheel cylinder hydraulic pressure that a sum of the regenerative braking force input from a control unit of the regenerative braking apparatus and a hydraulic braking force corresponding to the target wheel cylinder hydraulic pressure can satisfy the vehicle deceleration requested by the driver. In the VDC, the target wheel cylinder hydraulic pressure calculation portion 102 calculates the target wheel cylinder hydraulic pressure for each of the wheels FL to RR so as to, for example, realize a desired state of a vehicle motion based on a detected amount of the state of the vehicle motion (a lateral acceleration or the like).

The pressing force brake creation portion 103 is configured to prohibit the stroke simulator 27 from functioning by controlling the shut-off valves 21, the stroke simulator IN valve 31, and the stroke simulator OUT valve 32 in the opening directions, the opening direction, and the closing direction, respectively, thereby realizing the pressing force brake that creates the wheel cylinder hydraulic pressures from the master cylinder pressure. The boosting control portion 104 controls the shut-off valves 21 in the closing directions to thus make the hydraulic control portion 60 ready for the creation of the wheel cylinder hydraulic pressures by the pump unit 7, thereby performing the boosting control. The boosting control portion 104 controls each of the actuators to realize the target wheel cylinder hydraulic pressures. Further, the ECU 100 closes the stroke simulator IN valve 31 and controls the stroke simulator OUT valve 32 in the opening direction, thereby activating the stroke simulator 27. The boosting control switching portion 105 controls the operation of the master cylinder unit 5 to switch the pressing force brake and the boosting control based on the calculated target wheel cylinder hydraulic pressure. More specifically, upon detection of a start of the brake operation by the brake operation amount detection portion 101, the boosting control switching portion 105 causes the pressing force brake creation portion 103 to create the wheel cylinder hydraulic pressures if the calculated target wheel cylinder hydraulic pressure is equal to or lower than a predetermined value (for example, corresponding to a maximum value of the vehicle deceleration G that would be generated when the vehicle is normally braked without being suddenly braked). On the other hand, the boosting control switching portion 105 causes the boosting control portion 104 to create the wheel cylinder hydraulic pressures if the target wheel cylinder hydraulic pressure calculated at the time of the operation of pressing the brake exceeds the above-described predetermined value.

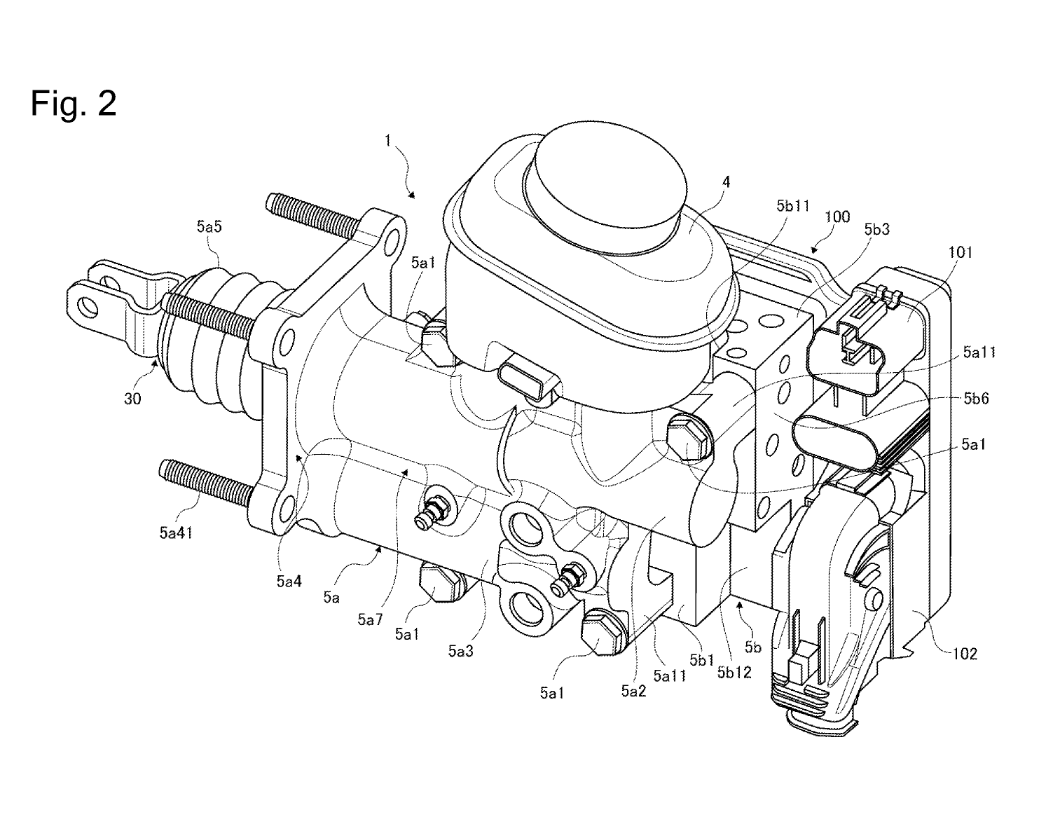

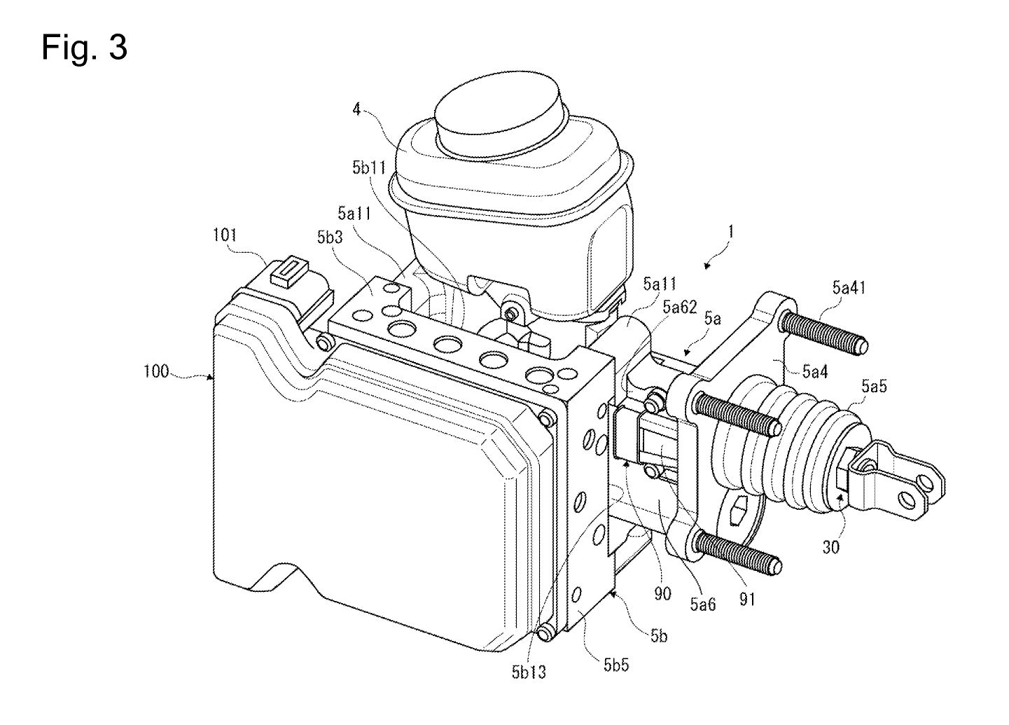

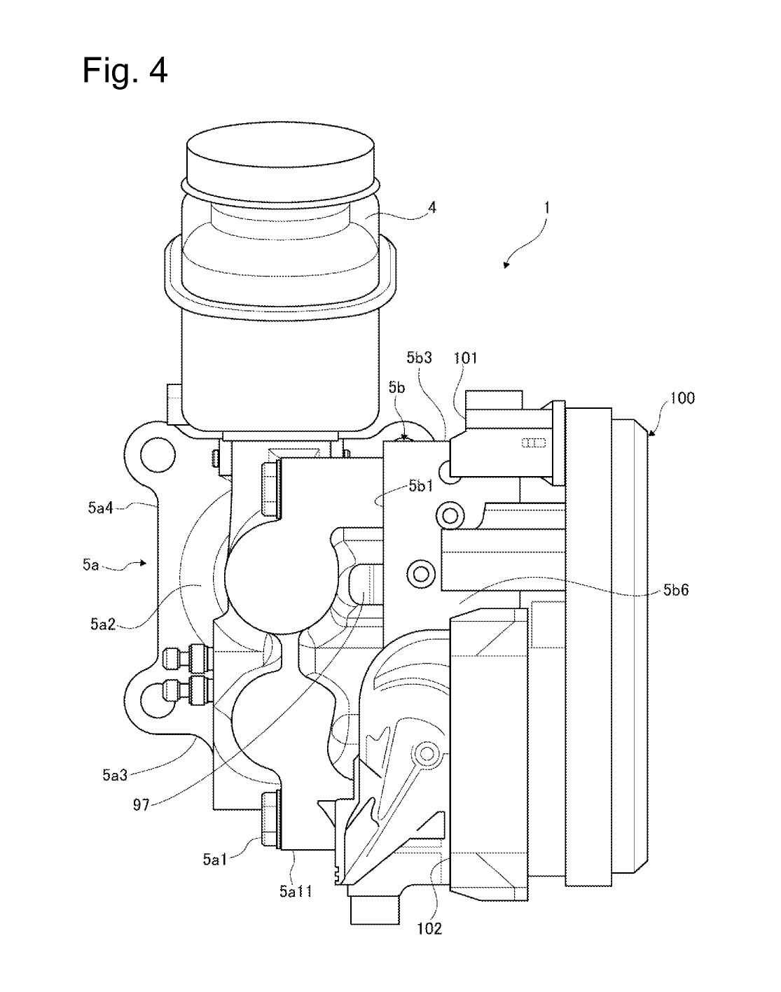

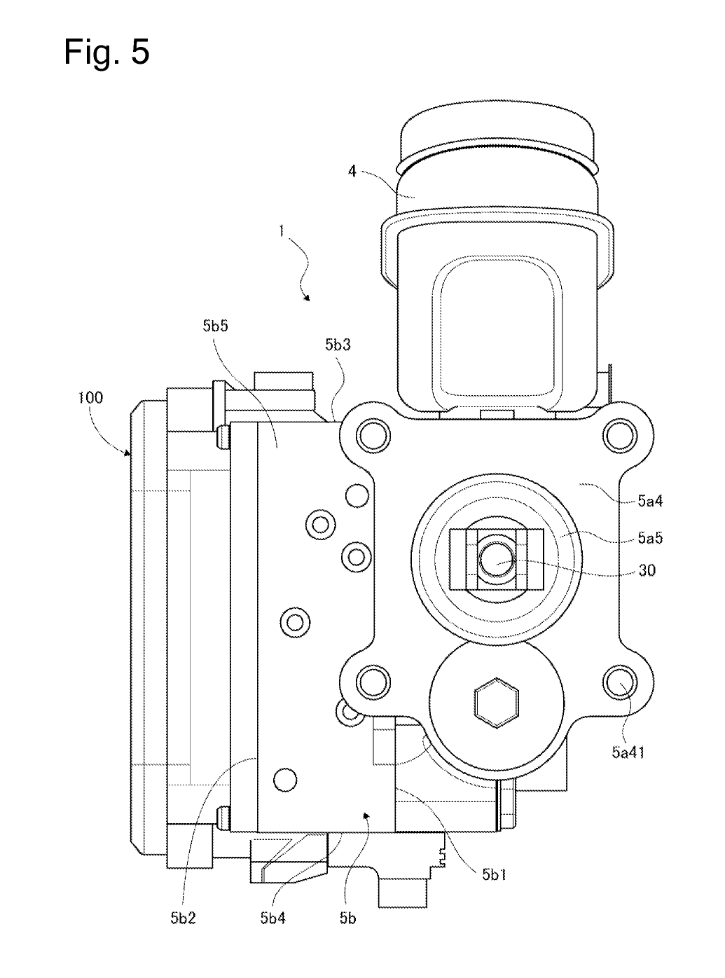

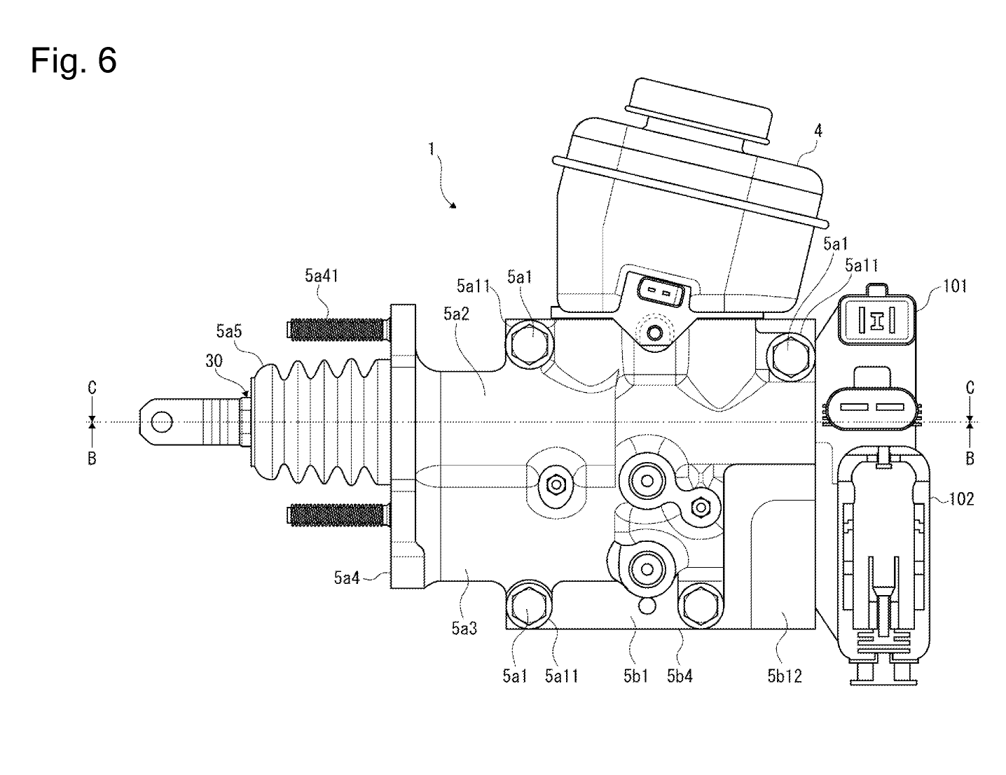

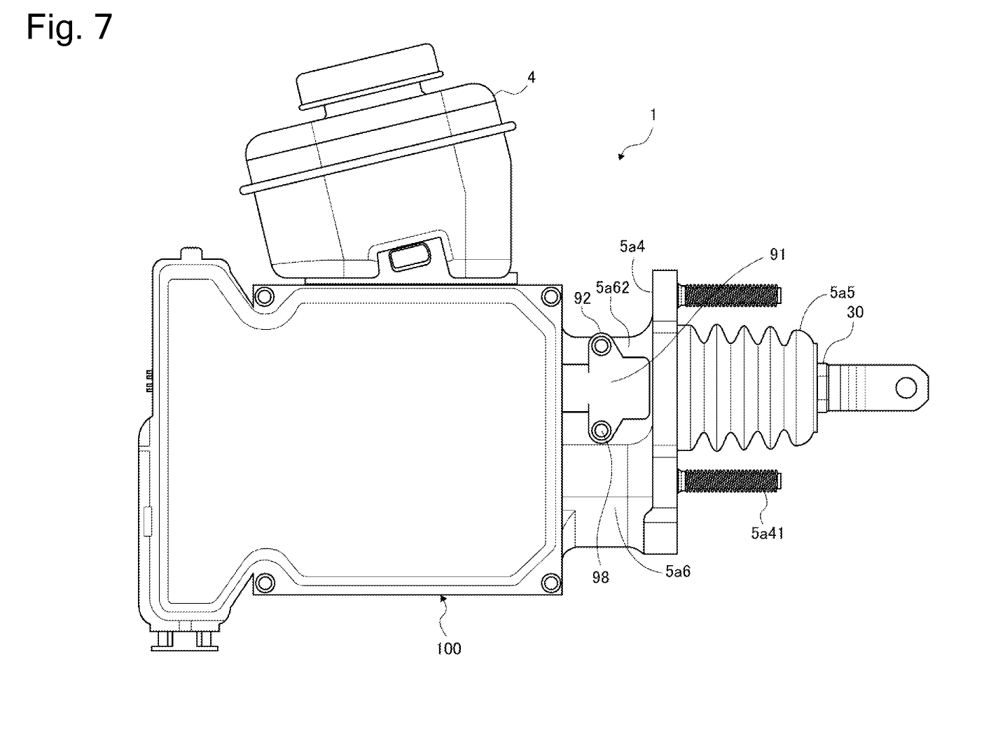

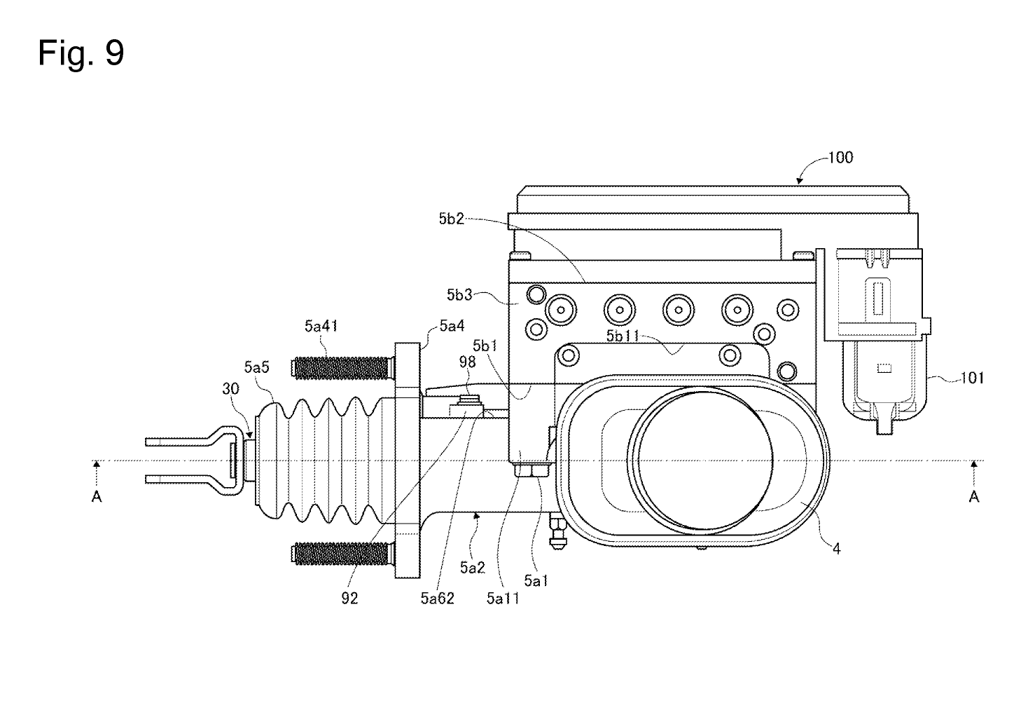

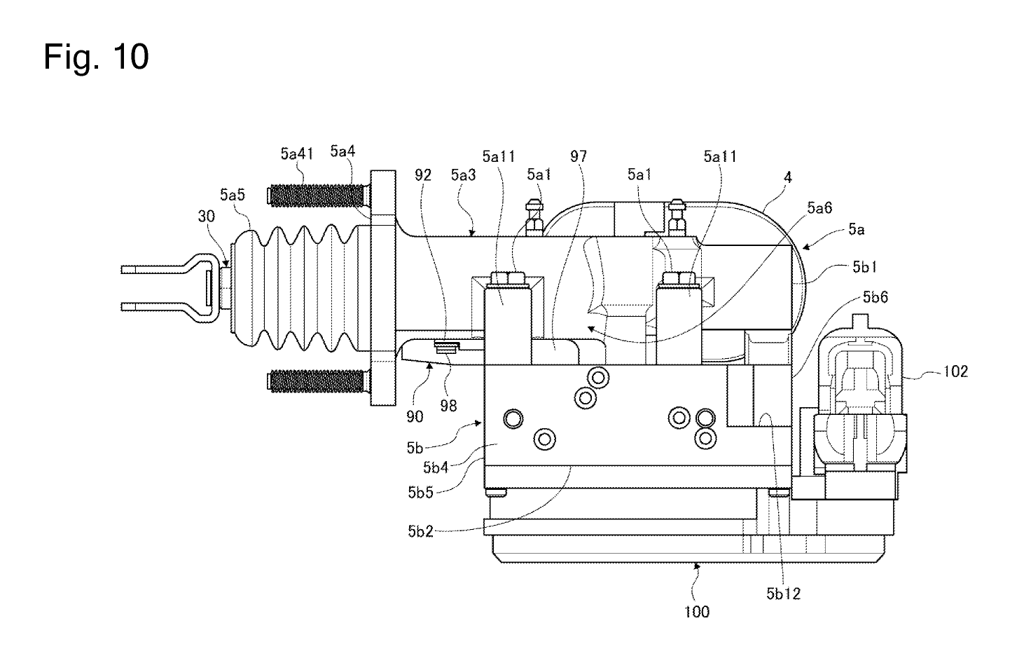

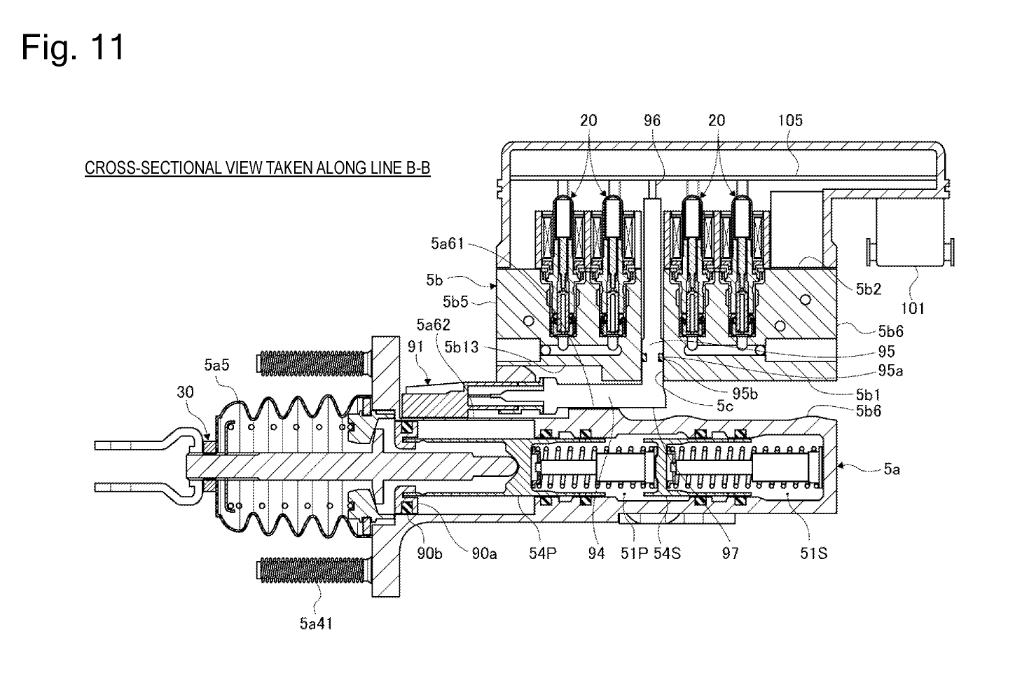

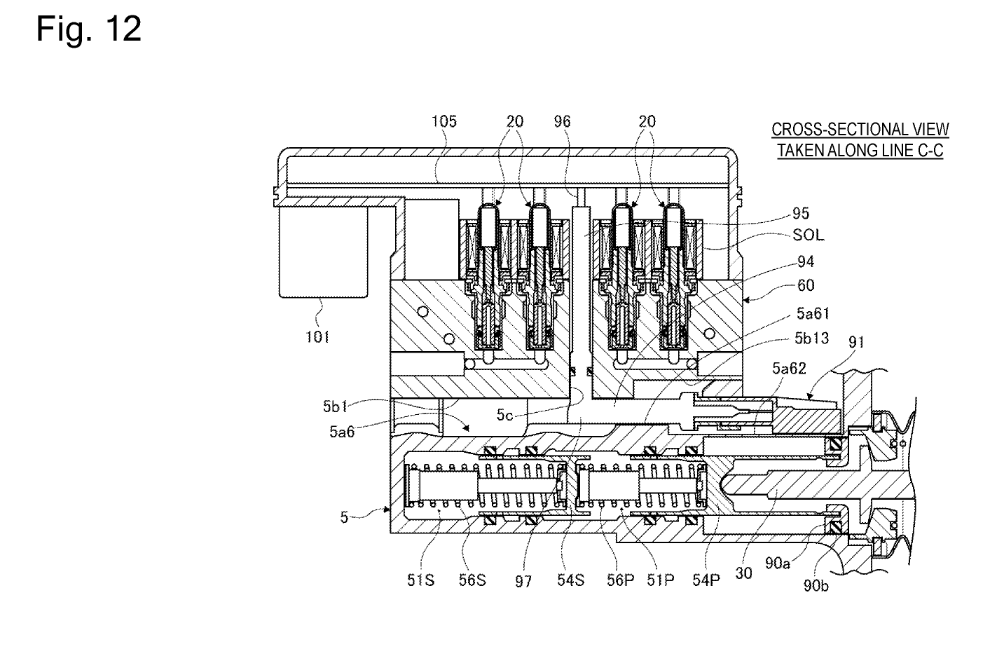

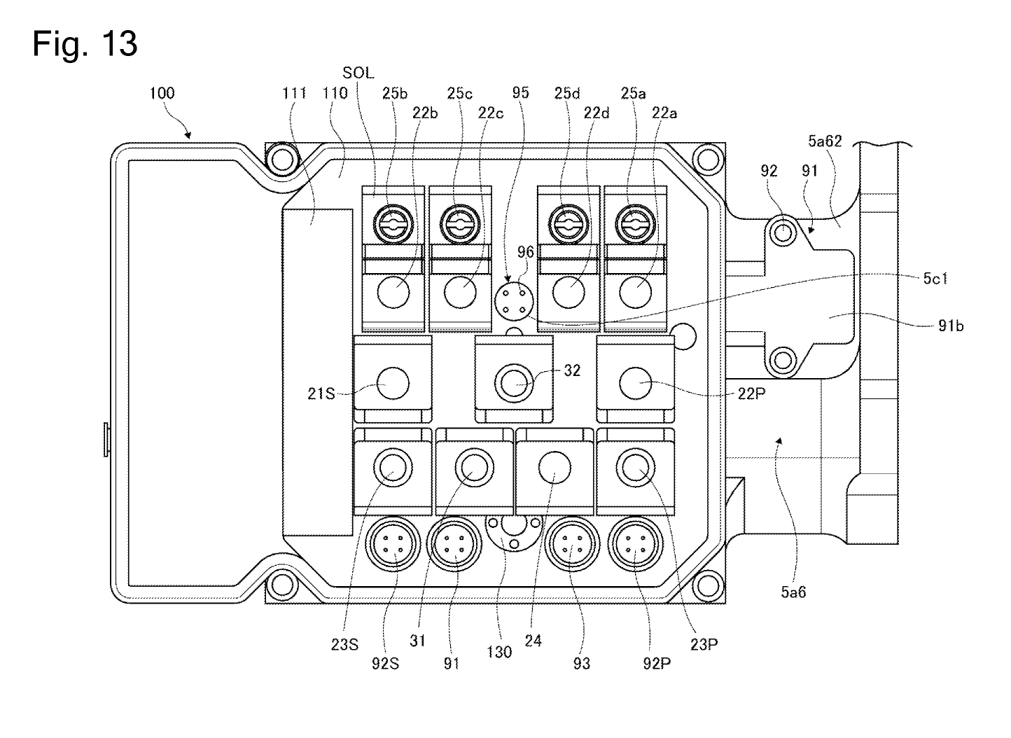

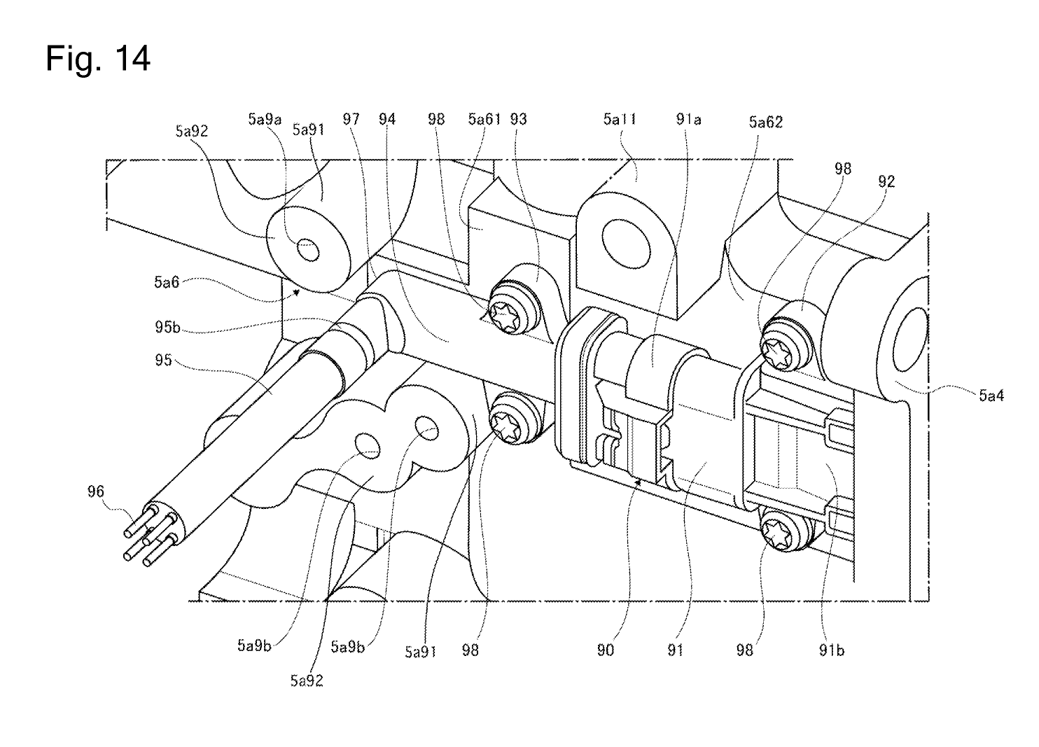

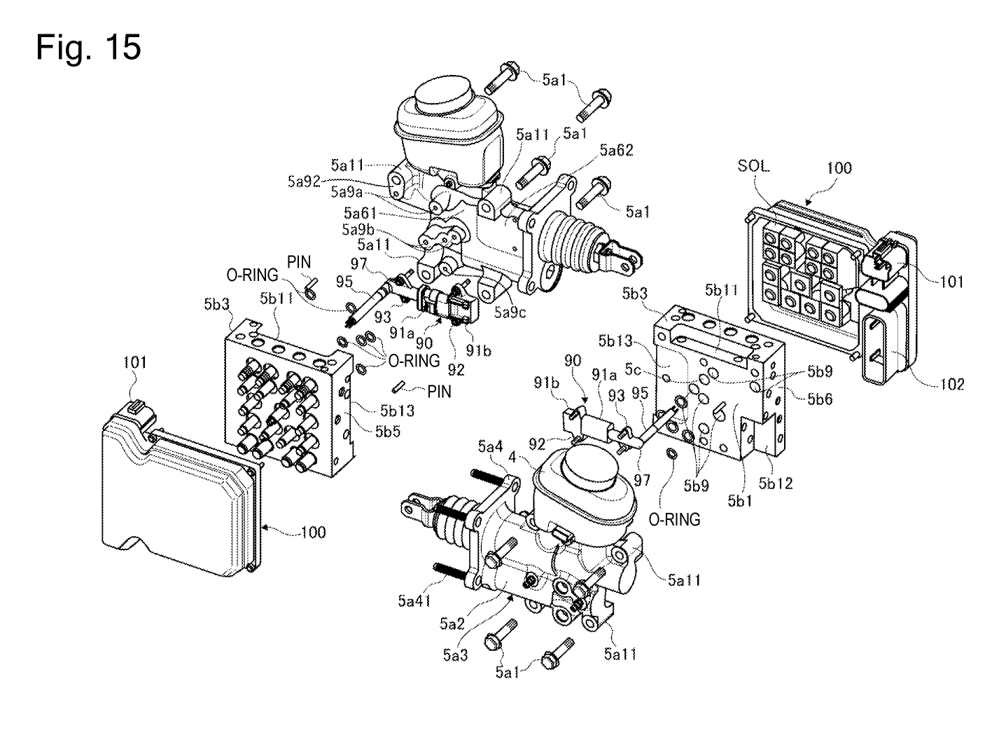

FIGS. 2 and 3 are perspective views illustrating the brake apparatus according to the first embodiment. FIG. 4 is a front view illustrating the brake apparatus according to the first embodiment. FIG. 5 is a back view illustrating the brake apparatus according to the first embodiment. FIG. 6 is a left side view illustrating the brake apparatus according to the first embodiment. FIG. 7 is a right side view illustrating the brake apparatus according to the first embodiment. FIG. 8 is a cross-sectional view illustrating the brake apparatus according to the first embodiment taken along a line A-A. FIG. 9 is a plan view illustrating the brake apparatus according to the first embodiment. FIG. 10 is a bottom view illustrating the brake apparatus according to the first embodiment. FIG. 11 is a cross-sectional view illustrating the brake apparatus according to the first embodiment taken along a line B-B. FIG. 12 is a cross-sectional view illustrating the brake apparatus according to the first embodiment taken along a line C-C. FIG. 13 illustrates an internal layout of the ECU provided to the brake apparatus according to the first embodiment. FIG. 14 is an enlarged perspective view of the stroke sensor portion provided to the brake apparatus according to the first embodiment. FIG. 15 is an exploded perspective view illustrating the brake apparatus according to the first embodiment. The pump unit 7 is mounted at a predetermined position on a vehicle body side. In the first embodiment, the position where the pump unit 7 is mounted is not especially specified. Examples of the position where the pump unit 7 is mountable include a position below the brake apparatus in a vertical direction of the vehicle in an engine room, and another efficiently usable space. The mounted pump unit 7 is connected to the brake apparatus via a pipe and/or a wiring.

The brake apparatus 1 includes a first unit housing 5a, a second unit housing 5b, and the ECU 100. The first unit housing 5a contains the master cylinder portion 50 and the stroke simulator 27 therein. The second unit housing 5b contains the various kinds of electromagnetic valves 20, the hydraulic sensors, and the like therein, and also includes a plurality of oil passages formed by piercing the second unit housing 5b. The ECU 100 is used to output a control instruction signal calculated based on various kinds of sensor signals and the like to the various kinds of electromagnetic valves 20.

The first unit housing 5a includes a first side surface 5a6 and a second side surface 5a7. The first side surface 5a6 faces the second unit housing 5b. The first side surface 5a6 has a shape generally cylindrically bulging toward one side where the second unit housing 5b is located, and a flat surface formed by flatly cutting out the bulging portion. The second side surface 5a7 is located opposite from the first side surface 5a6, and has a plurality of shapes generally cylindrically bulging toward an opposite side from the one side where the second unit housing 5b is located. The first unit housing 5a includes a master cylinder container portion 5a2 and a stroke simulator container portion 5a3. The master cylinder container portion 5a2 contains the master cylinder portion 50 therein. The stroke simulator container portion 5a3 contains the stroke simulator 27 therein.

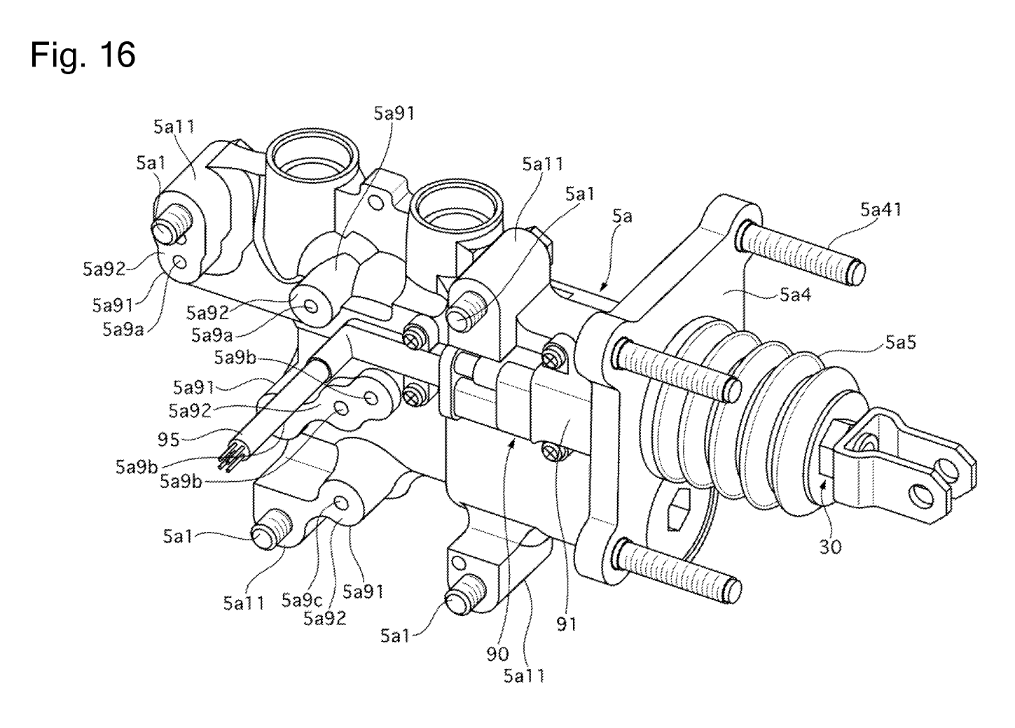

FIG. 16 is a perspective view illustrating a configuration of the first unit housing according to the first embodiment. The first side surface 5a6 includes a plurality of connection ports 5a9 connected to the oil passages formed in the first unit housing 5a. Each of the connection ports 5a9 is formed in a connection portion 5a91 generally cylindrically raised from the first side surface 5a6. One connection portion 5a91 is formed for one connection port 5a9 at a connection port 5a9a and a connection port 5a9c disposed at an upper portion and a lower portion of the first side surface 5a6 as viewed in FIG. 16, respectively, among the connection ports 5a9. Further, a connection portion 5a91 on an upper left side, i.e., one side located away from the brake pedal, among the connection portions 5a91, is positioned adjacent to a first flange portion 5a11, which will be described below, and is raised integrally with the first flange portion 5a11. The connection port 5a9 and the first flange portion 5a11 are positioned in proximity to each other, which makes it difficult to secure the thicknesses of the first flange portion 5a11 and the connection portion 5a91. However, the connection portion 5a91 and the first flange portion 5a11 are constructed by integrally raising them, which achieves both the acquisition of strength of the flange and the acquisition of strength of the connection portion at the same time.

On the other hand, connection portions 5a91 of three connection ports 5a9b disposed in proximity to one another at a generally central portion of the first side surface 5a6 as viewed in FIG. 16, among the connection ports 5a9, are formed while being raised integrally with the adjacent connection portions 5a91. This configuration can acquire the strength of the connection portions 5a91 themselves by integrally forming the plurality of connection portions, even when the positioning of the connection ports 5a9 in proximity to one another makes it difficult to secure the thicknesses of the connection portions 5a91. An end of each of the connection portions 5a91 includes a connection end surface 5a92 in abutment with the first attachment surface 5b1 of the second unit housing 5b including ports 5b9, which will be described below. The connection end surface 5a92 of each of the connection ports 5a9 is formed at a position that allow each of them to be positioned within generally the same plane. All of the raised connection portions 5a91 and an end surface of the first flange portion 5a11, which will be described below, are formed at generally the same height (positioned within generally the same plane).

As illustrated in the cross-sectional view of FIG. 8 taken along the line A-A, the stroke simulator 27 is contained in a cylinder portion formed by piercing the first unit housing 5a. This cylinder portion is sealingly closed by the plug member 27c. Further, a flange portion 5a4 is formed on one side of the first unit housing 5a that is closer to the push rod 30. The flange portion 5a4 is used to mount the brake apparatus 1 onto an installment panel of the vehicle. The brake apparatus 1 is mounted onto the installment panel by mounting bolts 5a41 provided at four corners of the flange portion 5a4. A rubber boot 5a5 is disposed around an outer periphery of the push rod 30. The rubber boot 5a5 prevents entry of dust and the like. Further, the reservoir 4 is mounted on the first unit housing 5a. The first unit housing 5a includes first flange portions 5a11 for fixing the first unit housing 5a and the second unit housing 5b with use of fixation bolts 5a1. In the first embodiment, the first unit housing 5a includes the flange portions 5a11 at four portions.

The first unit housing 5a includes a flat surface portion 5a61 (a thinned portion), which is formed by flatly cutting out the generally cylindrically bulging portion, on the one side where the first side surface 5a6 is located and one side of the master cylinder container portion 5a2 where the flange portion 5a4 is located. This flat surface portion 5a61 includes a flat sensor attachment surface 5a62, which is a recessed portion formed by further deeply cutting out the surface portion 5a61. The stroke sensor 90 is attached on this sensor attachment surface 5a62 and the flat surface portion 5a61. Now, refer to the cross-sectional view of FIG. 11 taken along the line B-B and the cross-sectional view of FIG. 12 taken along the line C-C. In the master cylinder portion 50 according to the first embodiment, a holder member 90a is attached to the primary piston 54P connected to the push rod 30. A permanent magnet 90b is held around an outer periphery of this holder member 90a. This permanent magnet 90b carries out a stroke while having a predetermined correlation with the pedal stroke amount of the brake pedal 2. A Hall element is contained in the stroke sensor 90. The stroke sensor 90 detects the stroke amount by detecting a change in a magnetic flux due to the stroke of this permanent magnet 90b with use of the Hall element. It is desirable to position the stroke sensor 90 and the permanent magnet 90b as close to each other as possible to highly accurately detect the change in the magnetic flux. Therefore, the flat surface portion 5a61 and the sensor attachment surface 5a62 are formed by cutting out an outer surface of the master cylinder container portion 5a2 to thereby reduce a distance between the stroke sensor 90 and the permanent magnet 90b.

FIG. 14 is the perspective view illustrating the stroke sensor according to the first embodiment in an attached state. The stroke sensor 90 includes a detection portion 91, a first pipe 94 (an extension portion), a second pipe 95 (a connection end), and a connection terminal 96. The detection portion 91 contains the Hall element therein. The first pipe 94 contains therein a bus bar (a wiring made of a plate-shaped metallic piece), which is a wiring (a signal line) for transmitting an electric signal detected at the detection portion 91. The second pipe 95 is generally vertically erected from the first pipe 94 at an end 97 of the first pipe 94. The connection terminal 96 is provided at a tip of the second pipe 95 and is inserted in a terminal hole of a substrate, which will be described below. The first pipe 94 and the second pipe 95 are each made from a stiffer resin material than the bus bar, and surround the bus bar. A ring groove 95a is formed at a portion to be inserted into a through-hole 5c of the second unit housing 5b on an outer periphery of the second pipe 95. An O-ring 95b is set in the ring groove 95a. The O-ring 95b liquid-tightly defines one side and the other side of the second unit housing 5b where a first attachment surface 5b1 and a second attachment surface 5b2 are formed, respectively. The detection portion 91 includes a terminal collection portion 91a generally oval in cross-section, and a sensor portion 91b generally rectangular in cross-section. The terminal collection portion 91a is slightly floated from the sensor attachment surface 5a62. The sensor portion 91b is in close contact with the sensor attachment surface 5a62 and is reducing in thickness toward the one side where the flange portion 5a4 is located. Sensor fixation flanges 92 are provided on both sides of the sensor portion 91b. The sensor portion 91b is fixed so as to be arranged into close contact with the sensor attachment surface 5a62 with use of sensor fixation screws 98. These terminal collection portion 91a and sensor portion 91b are fixed so as to be positioned on the sensor attachment portion 5a62.

The first pipe 94, which is generally circular in cross-section and includes a flatly shaped surface in abutment with the flat surface portion 5a61, is connected to an opposite side of the terminal collection portion 91a from one side where the sensor portion 91b is located. Pipe fixation flanges 93 are provided on both sides of the first pipe 94. The stroke sensor 90 is fixed so as to be arranged in close contact with the flat surface portion 5a61 by the sensor fixation screws 98. The second pipe 95 provided at the end 97 of the first pipe 94 is generally circular in cross-section, and is disposed so as to be able to be erected by itself generally perpendicularly to the flat surface portion 5a61. Even if a force perpendicular to the flat surface portion 5a61 is applied to the connection terminal 96 and the second pipe 95, the end 97 is supported by the flat surface portion 5a61. Further, even if a force is applied to the connection terminal 96 and the second pipe 95 in a direction causing them to tilt, the pipe fixation flanges 93 can prevent or reduce the tilt of the second pipe 95. The second pipe 95 is vertically erected at a position that would correspond to a through-hole 5c formed at the second unit housing 5b, which will be described below, when the stroke sensor 90 is attached.

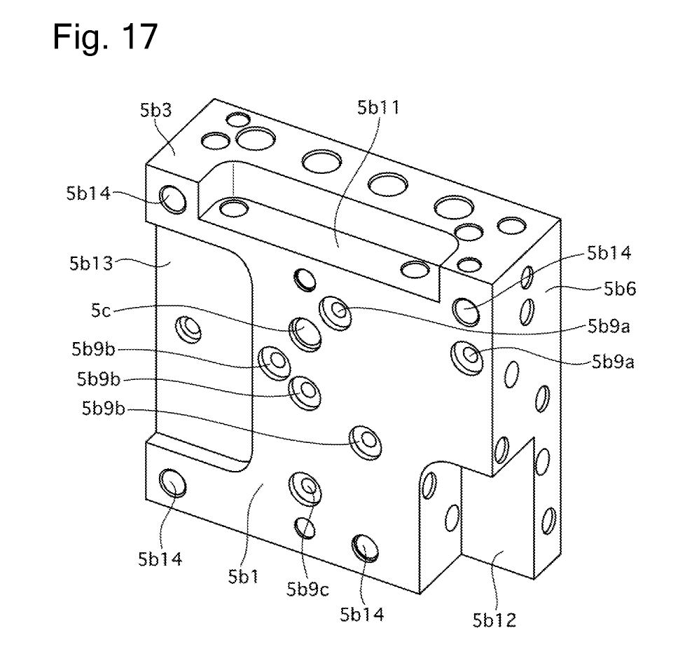

FIG. 17 is a perspective view illustrating the second unit housing according to the first embodiment as viewed from one side where the first attachment surface 5b1 is located. The second unit housing 5b is made of a generally cuboid aluminum block, and includes the first attachment surface 5b1, the second attachment surface 5b2, and an oil passage connection surface 5b3 (refer to FIGS. 1 and 2). The first unit housing 5a is attached to the second housing 5b on the first attachment surface 5b1 by the bolts 5a1. The second attachment surface 5b2 is formed at a position opposite from this first attachment surface 5b1. The oil passage connection surface 5b3 is formed between the first attachment surface 5b1 and the second attachment surface 5b2 on one side of the second unit housing 5b that is closer to the reservoir 4. The plurality of oil passages is formed in the second unit housing 5b by piercing the second unit housing 5b. Attachment holes for attaching the various kinds of electromagnetic valves 20 and the hydraulic sensors 91, 92, and 93 are formed on the second attachment surface 5b2 (refer to FIGS. 11, 12, and 15). The plurality of oil passages is formed on the oil passage connection surface 5b3 by piercing the oil passage connection surface 5b3, to which the pipes leading to the individual wheel cylinders 8 are connected. Further, coils of the electromagnetic valves 20, and the ECU 100 are attached to the second attachment surface 5b2. The ECU 100 includes a control substrate 105 that calculates a control amount based on the various kinds of sensor signals to output a control instruction. Further, the through-hole 5c, through which the second pipe 95 of the stroke sensor 90 penetrates, is opened at a position slightly offset from a center of the second unit housing 5b toward the one side where the brake pedal is located.

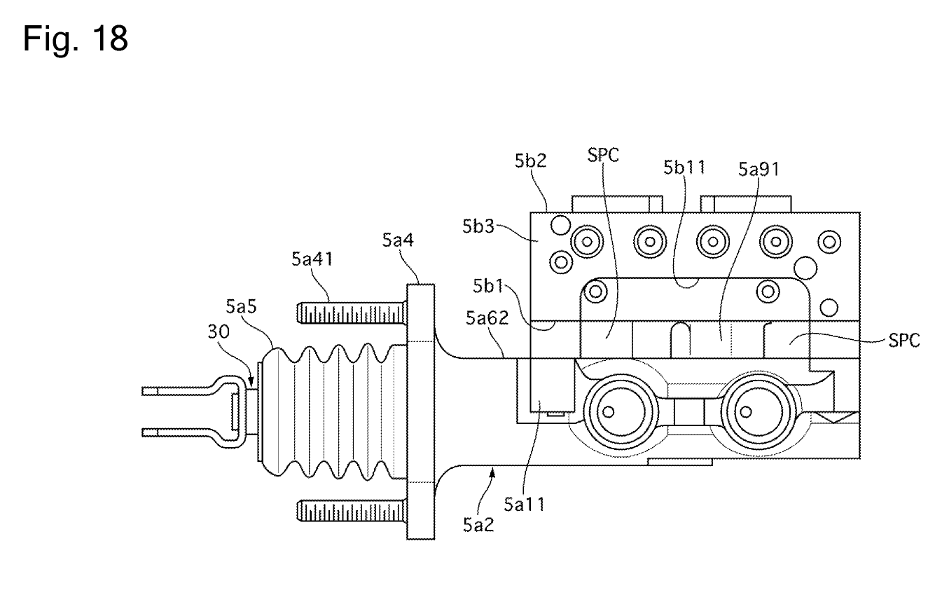

Four female screw holes 5b14 are formed on the first attachment surface 5b1. A female screw that is threadably engaged with a male screw of the bolt 5a1 is formed on an inner periphery of each of the female screw holes 5b14. A plurality of connection ports 5b9a, 5b9b, and 5b9c (hereinafter also collectively referred to as the connection ports 5b9) is formed on the first attachment surface 5b1. Each of the connection ports 5b9a, 5b9b, and 5b9c is connected to the connection port 5a9 of the first unit housing 5b by abutting against the connection portion 5a91. A stepped portion is formed at an outer periphery of an opening portion of each of the connection ports 5b9. A seal member or the like is contained in the stepped portion. FIG. 18 is a plan view when the first unit housing and the second unit housing according to the first embodiment are attached to each other. This plan view illustrates the brake apparatus without parts such as the ECU 100, the reservoir 4 and the stroke sensor 90 mounted thereon. The female screw holes 5b14 and the connection ports 5a9 are formed in a plane at generally the same height. Therefore, a space SPC is formed around the connection portions 5a91 when the end surfaces of the connection portions 5a91 and the first flange portion 5a11 that are raised on the first side surface 5a6 of the first unit housing 5a are in abutment with the first attachment surface 5b1.

A reservoir-side recessed portion 5b11, which is obtained by cutting out the aluminum material toward the second attachment surface 5b2, is formed on the first attachment surface 5b1 (refer to FIG. 9). The reservoir-side recessed portion 5b11 is opened on the one side where the oil passage connection surface 5b3 is located. In other words, the reservoir-side recessed portion 5b11, which is obtained by cutting out the aluminum material toward a bottom surface 5b4, is formed on the oil passage connection surface 5b3. This formation of the reservoir-side recessed portion 5b11 prevents a lower portion of the reservoir 4 and the second unit housing 5b from interfering with each other. Further, this formation reduces a distance between the reservoir 4 and the first unit housing 5b, thereby reducing a size of the entire apparatus. A connector-side recessed portion 5b12, which is obtained by cutting out the aluminum material toward the second attachment surface 5b2, is formed on the first attachment surface 5b1. The connector-side recessed portion 5b12 is formed at a position adjacent to a second connector unit portion, and the connector-side recessed portion 5b11 is opened to another side where the lower surface 5b4 is located, which is opposite from the oil passage connection surface 5b3. This formation of the connector-side recessed portion 5b12 can prevent a hand of a worker and the second unit housing 5b from interfering with each other when the second unit housing 5b is connected to a connector of the second connector portion 102. Therefore, the assemblability can be improved.

Further, a sensor-side recessed portion 5b13 (a thinned portion), which is obtained by cutting out the aluminum material toward the second attachment surface 5b2, is formed on the first attachment surface 5b1. The sensor-side recessed portion 5b13 is formed so as to correspond to a position where the stroke sensor 90 is set, and is opened to another side of the second unit housing 5b where a brake pedal-side side surface 5b5 is located. This formation of the sensor-side recessed portion 5b13 defines the space SPC between the first unit housing 5a and the second unit housing 5b. Disposing the stroke sensor 90 in this space SPC contributes to preventing the stroke sensor 90 and the second unit housing 5b from interfering with each other. Therefore, this configuration reduces a distance between the first unit housing 5a and the second unit housing 5b, thereby reducing the size of the entire apparatus.

The ECU 100 includes the control substrate 105, a first connector portion 101, and the second connector portion 102. The control substrate 105 is contained in a casing made from a resin material, and a microcomputer and the like are mounted on the control substrate 105. A wiring that outputs a driving signal from the control substrate 105 to the motor M is connected to the first connector portion 101. A CAN communication line that transmits and receives information between the control substrate 105 and another controller is connected to the second connector portion 102. As illustrated in the cross-sectional view of FIG. 11 taken along the line B-B and the cross-sectional view of FIG. 12 taken along the line C-C, the stroke sensor 90 and the various kinds of electromagnetic valves 20 are disposed at positions opposite from each other via the second unit housing 5b. This layout prevents or reduces an influence that otherwise might be exerted on the stroke sensor 90, even if a leakage flux occurs according to the power supply to the coils of the electromagnetic valves 20. When the stroke sensor 90 attached to the first unit housing 5a is attached to the second unit housing 5b, the second pipe 95 thereof extends through the through-hole 5c. Then, the connection terminal 96 reaches the control substrate 105, by which the stroke sensor 90 is electrically connected thereto. In this manner, the electric connection between the externally provided stroke sensor 90 and the control substrate 105 can be internally directly established similarly to the other electromagnetic valves, the sensors, and the like, which eliminates a necessity of additionally forming a connector portion and the like, realizing the low-cost attachment of the stroke sensor 90.

FIG. 13 illustrates the ECU according to the first embodiment with the substrate thereof removed therefrom, as viewed from the outside. A metallic plate 110 is set inside the ECU 100. A heat sink 111 for dissipating heat generated at solenoids SOL is set on the metallic plate 110. Further, through-holes are formed on the metallic plate 110 at positions respectively corresponding to the electromagnetic valves and the sensors. Plunger portions of the individual electromagnetic valves protruding from the through-holes are provided with the solenoids SOL surrounding the plunger portions, respectively. Each of the solenoids SOL is provided with a terminal extending in a direction perpendicular to a surface of the sheet of FIG. 3 and reaching the not-illustrated control substrate 105, thereby electrically connecting the solenoid SOL and the control substrate 105 to each other. A plate through-hole 5c1 is formed at a position that is a generally center of the metallic plate 110 and is slightly offset toward the brake pedal. The second pipe 95 of the stroke sensor 90 is inserted through the plate through-hole 5c1 to protrude therefrom, thereby connecting the stroke sensor 90 to the control substrate 105.

As illustrated in the exploded perspective view of FIG. 15, the stroke sensor 90 is attached to the first unit housing 5a. After that, the second unit housing 5b and the first unit housing 5a are attached to each other. At this time, they are attached to each other in such a manner that the second pipe 95 of the stroke sensor 90 extends through the through-hole 5c of the second unit housing 5b. Further, the connection ports 5a9 (a first port) are formed on the first side surface 5a6 of the first unit housing 5a. Each of the connection ports 5a9 establishes a liquid-tight connection with the oil passage for connecting the brake fluid flowing out from the first unit housing 5a to the oil passage formed in the second unit housing 5b.

The ports 5b9 (a second port) are formed on the first attachment surface 5b1 of the second unit housing 5b. Each of the ports 5b9 is opened at a position facing the connection port 5a9, and is connected to the connection portion 5a91 of the connection port 5a9 via an O-ring O-RING. When the first unit housing 5a and the second unit housing 5b are attached to each other, the positions of both the unit housings are determined by a positioning pin PIN, and the port 5b9 is brought into abutment with the port 5a9 with the O-RING interposed between the connection end surface 5a92 of the connection portion 5a91 and the port 5b9. Then, the bolts 5a1 are screwed in the female screw holes 5b14, thereby liquid-tightly joining the first unit housing 5a and the second unit housing 5b to each other. In this manner, the first unit housing 5a and the second unit housing 5b are joined to each other via the connection portions 5a91 when being connected to each other, by which the space opened to the outside of each of the unit housings can be formed around the connection portions 5a91. In other words, the force of tightening the bolts 5a1 is intensively received by the connection end surfaces 5a92, which are smaller than an area of the side surface of each of the unit housings. Therefore, surface pressures of the connection end surfaces 5a92 can be effectively increased, which contributes to the achievement of the liquid-tightness. Further, this configuration can prevent a torque of tightening the bolts 5a1 from being excessively increased, thereby allowing the thickness around the female screw portions 5b14 to be reduced and thus allowing a size of the entire apparatus to be reduced. Lastly, the ECU 100 is attached. At this time, in addition to the respective terminals of the electromagnetic valves and the sensors, the connection terminal 96 of the stroke sensor 90 is also connected to the control substrate 105 so as to be stuck into the terminal hole provided on the control substrate 105. Then, they are electrically connected to the control substrate 105 by soldering the respective terminal portions.

### Advantageous Effects of First Embodiment

In the following description, advantageous effects of the brake apparatus described in the first embodiment will be listed.

(1) The brake apparatus includes the first unit housing 5a (a master cylinder housing) including the primary piston 54P and the secondary piston 54S (a piston) configured to carry out the axial stroke in the cylinder formed therein via the push rod 30 (a rod) operable according to the operation performed by the driver on the brake pedal, and the connection ports 5a9 (the first port) connecting the inside and the outside of the cylinder to each other. The brake apparatus further includes the second unit housing 5b (a valve housing) including the ports 5b9 (the second port) connected to the connection ports 5a9, the oil passages through which the brake fluid introduced from the ports 5b9 flows, and the electromagnetic valves 20 configured to open and close these oil passages. One side of the first unit housing 5a where the first side surface 5a6 (one side surface) thereof is located is attached to one side of the second unit housing 5b where the first attachment surface 5b1 (one side surface) thereof is located. The brake apparatus further includes the connection portions 5a91 connecting the connection ports 5a9 and the ports 5b9 to each other between the first attachment surface 5b1 of the second unit housing 5b and the first side surface 5a6 of the first unit housing 5a, and the space SPC opened to the respective outsides of the housings around the connection portions. Therefore, the first embodiment can enhance the liquid-tightness due to the increases in the surface pressures at the connection portions between the connection ports 5a9 and the ports 5b9. Further, the first embodiment can reduce the weight of the brake apparatus due to the provision of the space SPC.
(2) In the brake apparatus described in the above item (1), the stroke sensor 90 is disposed in the space SPC. The stroke sensor 90 is configured to detect the amount of the axial stroke of the primary piston 54P and the secondary piston 54S.

The stroke sensor 90 is disposed in the space SPC, which allows the space to be efficiently utilized.

(3) The brake apparatus described in the above item (2) further includes the ECU 100 (a control unit) attached to another side of the second unit housing 5b where the second attachment surface 5b2 (another side surface) thereof is located. The ECU 100 is configured to be used to drive the electromagnetic valves 20 and receive the output of the stroke sensor 90. The brake apparatus further includes the through-hole 5c provided on the second unit housing 5b and formed in such a manner that the signal line for transmitting the output of the stroke sensor 90 to the ECU 100 extends therethrough.

Therefore, the first embodiment allows the stroke sensor 90 and the ECU 100 to be internally connected to each other similarly to the other electromagnetic valves 20 and the like, and thus can prevent or cut down the cost increase.

(4) In the brake apparatus described in the above item (3), the signal line is the bus bar.

Therefore, the first embodiment can realize the electric connection with a low-cost configuration.

(5) In the brake apparatus described in the above item (2), the ECU 100 includes the control substrate 105 (a controller), and the first connector portion 101 and the second connector portion 102 (a connector) configured to electrically connect the control substrate 105 and the stroke sensor 90 to the outside.

Therefore, the first embodiment allows power to be supplied from the outside to the control substrate 105, thereby allowing power to be supplied from the control substrate 105 to the stroke sensor 90, and thus can prevent a cost increase that otherwise would be caused due to a necessity of additionally providing a power supply line and the like for the stroke sensor 90.

(6) In the brake apparatus described in the above item (2), the stroke sensor 90 is the Hall element (a magnetic sensor) configured to detect the stroke of the primary piston 54P based on the magnetic change. The first unit housing 5a is the non-magnetic member. The stroke sensor 90 is attached to the sensor attachment surface 5a62 (a wall) of the first unit housing 5a.

In other words, since the first unit housing 5a is the non-magnetic member, the first embodiment improves accuracy of detecting the motion of the primary piston 54P based on the magnetic change while eliminating a magnetic influence. Further, since the stroke sensor 90 is attached to the first unit housing 5a, the first embodiment can reduce the distance to the primary piston 54P, thereby improving the detection accuracy.

(7) In the brake apparatus described in the above item (6), the signal line of the stroke sensor 90 is disposed in the space SPC.

Therefore, the first embodiment can efficiently utilize the space SPC, thereby reducing the size of the brake apparatus.

(8) In the brake apparatus described in the above item (7), the signal line includes the first pipe 94 (an extension portion) extending along the first unit housing 5a in the space SPC, and the second pipe 95 (a connection end) configured to transmit the signal to the ECU 100 by being erected from the first pipe 94 in the direction toward the second unit housing 5b and being connected to the ECU 100 from the axial direction.

Therefore, the first embodiment allows the force applied in the axial direction of the second pipe 95 to be received by the flat surface portion 5a61 of the first unit housing 5a when the stroke sensor 90 and the control substrate 105 are connected to each other, and thus can improve the assemblability.

(9) In the brake apparatus described in the above item (8), the second pipe 95 is erected so as to be located at the position corresponding to the through-hole 5c.

Therefore, the first embodiment can improve the assemblability when each of the housings and the ECU 100 are attached.

(10) In the brake apparatus described in the above item (1), the space SPC is the recessed portion formed on the first side surface 5a6 of the first unit housing 5a. In other words, the recessed portion is formed on the first side surface 5a6, which establishes a state in which the connection portions 5a91 protrude with the space formed around them.

Therefore, the first embodiment can reduce the weight of the first unit housing 5a.

(11) In the brake apparatus described in the above item (10), the first unit housing 5a is a casting. The connection ports 5a9 are the connection portions 5a91 (a protrusion portion) formed on the first side surface 5a6 of the first unit housing 5a and protruding toward the second unit housing side where the second unit housing 5b is located. The space SPC is formed around the connection portions 5a91.

Therefore, the first embodiment can easily form the space by casting.

(12) The first side surface 5a6 of the second unit housing 5b includes the ports 5b9 formed thereon, the abutment surfaces in abutment with the connection portions 5a91, and the sensor-side recessed portion 5b13 (the thinned portion) formed by being recessed from the abutment surfaces toward the another side where the second side surface 5b2 is located.

Therefore, the first embodiment can reduce the weight of the brake apparatus.

(13) The master cylinder includes the primary piston 54P and the secondary piston 54S (a piston) configured to carry out the axial stroke in the cylinder formed inside the master cylinder via the push rod 30 (a rod) operable according to the operation performed by the driver on the brake pedal, and the connection ports 5a9 (the first port) formed on the first side surface 5a6 (one side surface). The connection ports 5a9 connect the inside and the outside of the cylinder to each other. The master cylinder is configured in such a manner that the second unit housing 5b (a housing) including the oil passages formed therein and the ports 5b9 (the second port) connected to the connection ports 5a9 is attached on the first side surface 5a6 of the first unit housing 5a (a master cylinder housing) of the master cylinder. The first side surface 5a6 of the master cylinder includes the connection portions 5a91 (a protrusion portion) where the connection ports 5a9 are formed, and the space SPC formed around the connection portions 5b91.

Therefore, the first embodiment can enhance the liquid-tightness due to the increases in the surface pressures at the connection portions between the connection ports 5a9 and the ports 5b9. Further, the first embodiment can reduce the weight of the brake apparatus due to the provision of the space SPC.

(14) In the brake apparatus described in the above item (13), the stroke sensor 90 is disposed in the space SPC. The stroke sensor 90 is configured to detect the amount of the axial stroke of the primary piston 54P and the secondary piston 54S.

The stroke sensor 90 is disposed in the space SPC, which allows the space to be efficiently utilized.

(15) The brake apparatus includes the first unit housing 5a (a master cylinder housing) including the primary piston 54P and the secondary piston 54S (a piston) configured to carry out the axial stroke in the cylinder formed therein according to the driver's brake operation state, and the connection ports 5a9 (the first port) connecting the inside and the outside of the cylinder to each other. The brake apparatus further includes the second unit housing 5b (a housing) including the ports 5b9 (the second port) configured to be used to introduce the brake fluid flowing out from the connection ports 5a9 into the oil passages formed therein, and the first attachment surface 5b1 (one side surface) configured to be attached to the first side surface 5a6 (one side surface) of the first unit housing 5a. The individual housings are in abutment with each other on one side where the first side surface 5a6 and the first attachment surface 5b1 are located via the portions of the respective ports thereof, and include the space SPC around the portions of the ports.

Therefore, the first embodiment can enhance the liquid-tightness due to the increases in the surface pressures at the connection portions between the connection ports 5a9 and the ports 5b9. Further, the first embodiment can reduce the weight of the brake apparatus due to the provision of the space SPC.

(16) In the brake apparatus described in the above item (15), the stroke sensor 90 is disposed in the space SPC. The stroke sensor 90 is configured to detect the amount of the axial stroke of the primary piston 54P and the secondary piston 54S (the piston).

The stroke sensor 90 is disposed in the space SPC, which allows the space to be efficiently utilized.

(17) In the brake apparatus described in the above item (16), the second unit housing 5b includes the electromagnetic valves 20 configured to be used to close and open the oil passages, and the ECU 100 (a control unit) attached to another side of the second unit housing 5b where the second attachment surface 5b2 (another side surface) thereof is located. The ECU 100 is configured to be used to drive the electromagnetic valves 20 and receive the output of the stroke sensor 90.

Therefore, the first embodiment allows the stroke sensor 90 and the ECU 100 to be internally connected to each other similarly to the other electromagnetic valves 20 and the like, and thus can prevent or cut down the cost increase.

(18) In the brake apparatus described in the above item (2), the space SPC is in communication with between the respective outer walls of the housings that face each other.

Therefore, the first embodiment can improve the performance of dissipating the heat.

### Second Embodiment

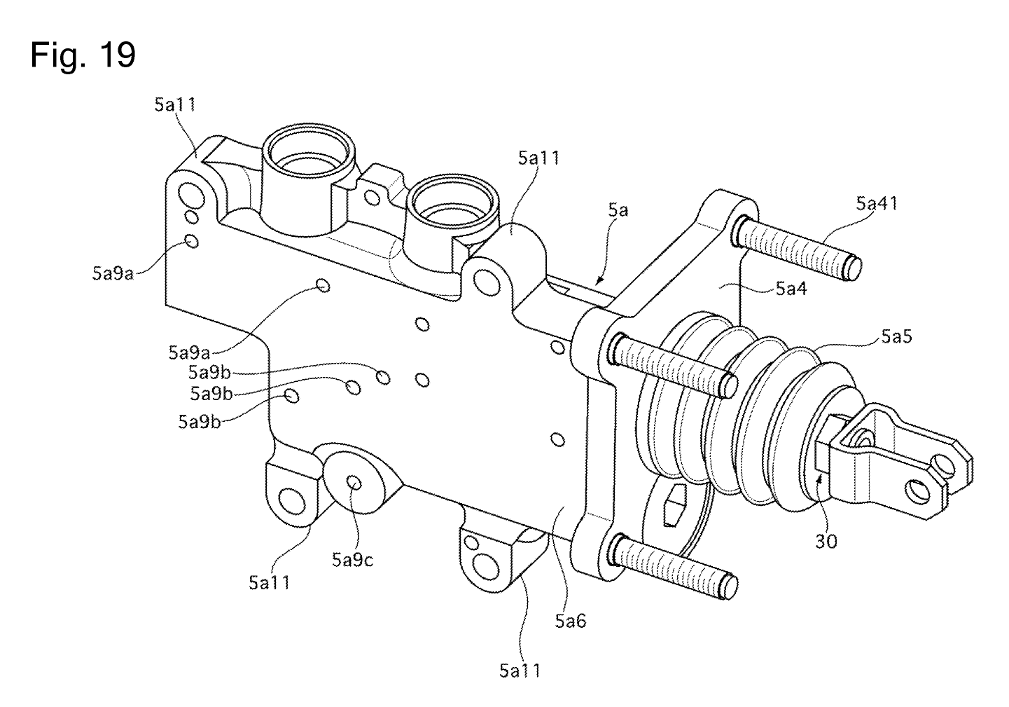

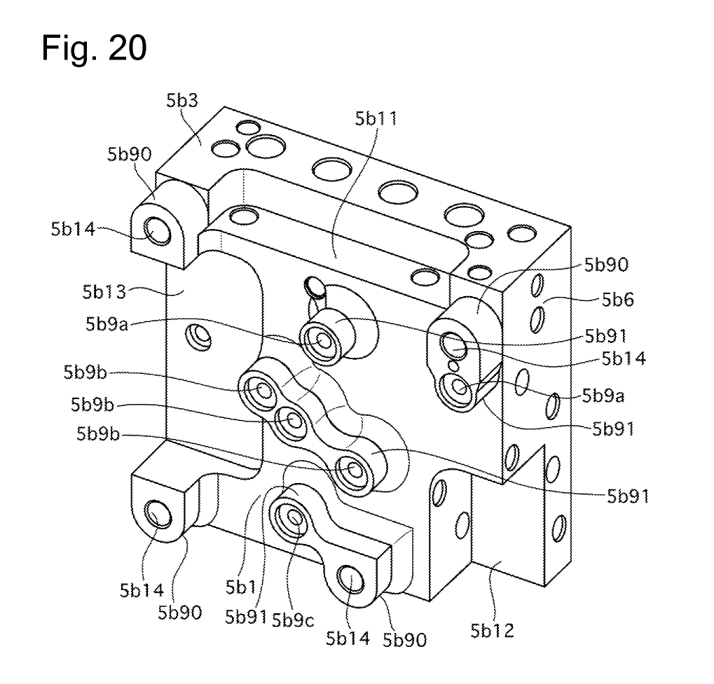

Next, a second embodiment will be described. The second embodiment is similar to the first embodiment in terms of a basic configuration thereof, and therefore will be described focusing only differences from the first embodiment. FIG. 19 is a perspective view illustrating a configuration of a first unit housing according to the second embodiment. FIG. 20 is a perspective view illustrating a configuration of a second unit housing according to the second embodiment. In the first embodiment, the raised connection portions 5a91 are formed on the first side surface 5a6 of the first unit housing 5a. On the other hand, the second embodiment is different therefrom in terms of such a configuration that the side surface 5a6 of the first unit housing 5a is flatly formed while raised connection portions 5b91 are formed on the first attachment surface 5b1 of the second unit housing 5b. Fastening connection portions 5b90 are also formed at portions corresponding to the female screw holes 5b14 according to the rises of the connection portions 5b91. The fastening connection portions 5b90 of the female screw holes 5b14, and the connection portions 5b91 are formed in a plane at generally the same height. Therefore, when the flatly formed first side surface 5a6 of the first unit housing 5a is in abutment with the first attachment surface 5b1, the space SPC similar to the space illustrated in FIG. 18 is formed around the connection portions 5b91.

In the above-described manner, the second embodiment can bring about the following advantageous effects.

(19) In the brake apparatus described in the above item (1), the space SPC is the recessed portion formed on the first attachment surface 5b1 of the second unit housing 5b. In other words, the space SPC is formed around the connection portions 5b91 raised on the first attachment surface 5b1.

Therefore, the first embodiment can reduce the weight of the second unit housing 5b.

(20) In the brake apparatus described in the above item (19), the first attachment surface 5b1 of the second unit housing 5b includes the ports 5b9 formed thereon, the abutment surfaces in abutment with the connection ports 5a9, and the sensor-side recessed portion 5b13 (the thinned portion) formed by being recessed from the abutment surfaces toward the another side where the second side surface 5b2 is located.

Therefore, the first embodiment can reduce the weight of the brake apparatus.

Having described merely several embodiments of the present invention, it is apparent to those skilled in the art that the embodiments described as examples can be modified or improved in various manners without substantially departing from the novel teachings and advantages of the present invention. Therefore, such embodiments modified or improved in various manners are intended to be also contained in the technical scope of the present invention. The above-described exemplary embodiments may be even arbitrarily combined.

This application claims priority under the Paris Convention to Japanese Patent Application No. 2014-145057 filed on Jul. 15, 2014. The entire disclosure of Japanese Patent Application No. 2014-145057 filed on Jul. 15, 2014 including the specification, the claims, the drawings, and the summary is incorporated herein by reference in its entirety.

### REFERENCE SIGNS LIST

1 brake apparatus
2 brake pedal
4 reservoir
5 master cylinder unit
5a first unit housing
5b second unit housing
5a2 master cylinder container portion
7 pump unit
8 wheel cylinder
12a intake pipe
20 electromagnetic valve
27 stroke simulator
30 push rod
50 master cylinder portion
54 piston
60 hydraulic control portion
70 gear pump
90 stroke sensor
200 installment panel
M motor

1. A brake apparatus comprising:
a master cylinder housing including a cylinder formed therein, a piston configured to carry out an axial stroke in the cylinder, and a first port that connects connecting an inside of the cylinder and an outside of the cylinder to each other;
a valve housing including a second port connected to the first port, an oil passage through which brake fluid introduced from the second port flows, an electromagnetic valve configured to open and close the oil passage, and one side surface which is attached to one side surface of the master cylinder housing;
a connection portion provided between the one side surface of the valve housing and the one side surface of the master cylinder housing and configured to connect the first port and the second port to each other; and
a space formed outside each of the housings around the connection portion.

2. The brake apparatus according to claim 1, wherein a stroke sensor is disposed in the space, the stroke sensor being configured to detect an amount of the axial stroke of the piston.

3. The brake apparatus according to claim 2, further comprising:
a control unit attached to another side of the valve housing and configured to drive the electromagnetic valve and receive an output of the stroke sensor; and
a through-hole provided on the valve housing, and formed in such a manner that a signal line for transmitting the output of the stroke sensor to the control unit extends therethrough.

4. The brake apparatus according to claim 3, wherein the signal line is a bus bar.

5. The brake apparatus according to claim 2, wherein the control unit includes a controller, and a connector configured to electrically connect the controller and the stroke sensor to an outside.

6. The brake apparatus according to claim 2, wherein the stroke sensor is a magnetic sensor configured to detect the stroke of the piston based on a magnetic change,
wherein the master cylinder housing is a non-magnetic member, and
wherein the stroke sensor is attached to a wall of the master cylinder housing.

7. The brake apparatus according to claim 6, wherein the signal line of the stroke sensor is disposed in the space.

8. The brake apparatus according to claim 7, wherein the signal line includes
an extension portion extending along the master cylinder housing in the space, and
a connection end configured to transmit a signal to the control unit by being erected from the extension portion in a direction toward the valve housing and being connected to the control unit from an axial direction.

9. The brake apparatus according to claim 8, further comprising:
the control unit attached to another side of the valve housing and configured to drive the electromagnetic valve and receive an output of the stroke sensor; and
a through-hole provided on the valve housing,
wherein the signal line for transmitting the output of the stroke sensor to the control unit extends through the through-hole, and
wherein the connection end is erected so as to be located at a position corresponding to the through-hole.

10. The brake apparatus according to claim 1, wherein the space is a recessed portion formed on the one side surface of the master cylinder housing.

11. The brake apparatus according to claim 10, wherein the master cylinder housing is a casting,
wherein the first port is a protrusion portion that is formed on the one side surface of the master cylinder housing and that protrudes toward a valve housing side, and
wherein the space is formed around the protrusion portion.

12. The brake apparatus according to claim 11, wherein the one side surface of the valve housing includes
the second port formed thereon,
an abutment surface in abutment with the protrusion portion, and
a thinned portion forming the space by being recessed from the abutment surface toward the other side surface.

13. The brake apparatus according to claim 1, wherein the space is a recessed portion formed on the one side surface of the valve housing.

14. The brake apparatus according to claim 13, wherein the one side surface of the valve housing includes the second port formed thereon, an abutment surface in abutment with the first port, and a thinned portion forming the space by being recessed from the abutment surface toward the other side surface.

15. The brake apparatus according to claim 1, wherein the space is in communication with between respective outer walls of the housings that face each other.

16. A master cylinder comprising:
a piston configured to carry out an axial stroke in a cylinder formed inside the master cylinder via a rod operable according to an operation performed by a driver on a brake pedal; and
a first port formed on one side surface of the master cylinder, the first port connecting an inside and an outside of the cylinder to each other,
wherein the master cylinder is configured in such a manner that a housing including an oil passage formed therein and a second port connected to the first port is attached on one side surface of a master cylinder housing of the master cylinder, and the one side surface of the master cylinder includes a protrusion portion where the first port is formed and a space formed around the protrusion portion.

17. The brake apparatus according to claim 16, wherein a stroke sensor is disposed in the space, the stroke sensor being configured to detect an amount of the axial stroke of the piston.

18. A brake apparatus comprising:
a master cylinder housing including a piston configured to carry out an axial stroke in a cylinder formed therein according to a driver's brake operation state, and a first port that connects an inside and an outside of the cylinder to each other;
a housing including a second port configured to be used to introduce brake fluid flowing out from the first port into an oil passage formed therein, and one side surface configured to be attached to one side surface of the master cylinder housing,
wherein the individual housings are in abutment with each other on one side surface via portions of the respective ports thereof, and include a space around the portions of the ports.

19. The brake apparatus according to claim 18, wherein a stroke sensor is disposed in the space, the stroke sensor being configured to detect an amount of the axial stroke of the piston.

20. The brake apparatus according to claim 19, wherein the housing includes an electromagnetic valve configured to close and open the oil passage, and a control unit attached to another side surface, the control unit being configured to drive the electromagnetic valve and receive an output of the stroke sensor.
